(19) United States
(12) Patent Application Publication
(10) Pub. No.: US 2014/0321552 A1
(43) Pub. Date: Oct. 30, 2014

(54) Optimization of Deblocking Filter Parameters

(71) Applicant: Dolby Laboratories Licensing Corporation, San Francisco, CA (US)

(72) Inventors: Yuwen He, San Diego, CA (US); Alexandros Tourapis, Milpitas, CA (US)

(73) Assignee: DOLBY LABORATORIES LICENSING CORPORATION, San Francisco, CA (US)

(21) Appl. No.: 14/358,703

(22) PCT Filed: Nov. 8, 2012
(86) PCT No.: PCT/US2012/064161

§ 371 Date: May 15, 2014

Related U.S. Application Data
(60) Provisional application No. 61/561,726, filed on Nov. 18, 2011.

(51) Int. Cl. H04N 19/86; H04N 19/50; H04N 19/117

(52) U.S. Cl. CPC H04N 19/00909; H04N 19/00066; H04N 19/00569
USPC 375/240.16; 375/240.24

(57) ABSTRACT

Systems and methods for selection of deblocking parameters are described. These systems and methods are dependent on and can be adjusted based on applications in which deblocking filtering is to be applied. Various deblocking parameters are iteratively applied in a filter, then the respective distortion values are evaluated in order to select the optimal deblocking parameter. Use of edge detection in relation to selection of deblocking parameters is also described.

### CROSS REFERENCE TO RELATED APPLICATIONS

This application claims priority to U.S. Provisional Patent Application No. 61/561,726 filed 18 Nov. 2011, hereby incorporated by reference in its entirety for all purposes.

The present application may be related to International Patent Application No. PCT/US2011/053218 filed on 26 Sep. 2011, incorporated herein by reference in its entirety for all purposes, including without limitation, for (i) region based asymmetric 3D coding and (ii) side-by-side arrangement of stereoscopic images, and sampling and upconversion of such arrangement.

### FIELD OF THE INVENTION

The disclosure relates generally to video processing. More specifically, it relates to subjective based post-filter optimization.

### BACKGROUND OF THE INVENTION

Block-based video coding schemes are widely adopted in current video coding standards such as MPEG-4 and H264/MPEG-4 AVC. One reason is that block-based video coding schemes can be adapted to be amenable to hardware implementation. However, block-based video coding schemes can introduce blocking artifacts. Additionally, the decoder may introduce blocking artifacts as a result of transmission errors. As a result of block-based operations and/or transmission errors, continuity of pixel information along block boundaries can be distorted and thus the block boundaries can lose continuity of pixel information, potentially degrading visual quality. The distortion along block boundaries can affect any edge information that may be present at pixels along these block boundaries.

### BRIEF DESCRIPTION OF DRAWINGS

The accompanying drawings, which are incorporated into and constitute a part of this specification, illustrate one or more embodiments of the present disclosure and, together with the description of example embodiments, serve to explain the principles and implementations of the disclosure.

FIGS. 1A and 1B show exemplary implementations of a video encoder and video decoder, respectively.

FIGS. 2A and 2B show a quality comparison of a particular image without and with deblocking filtering, respectively.

FIGS. 3A and 3B each show a 16×16 macroblock, where each block in the 16×16 macroblock contains 4×4 pixels.

FIG. 4 shows an exemplary weight function.

FIGS. 5A and 5B show quantized edge directions that can be identified by an edge detector.

FIG. 6 shows an edge and pixels associated with the edge.

FIG. 7 shows a flowchart of an embodiment of an edge detection process.

FIG. 8 shows threshold estimations based on a cumulative gradient magnitude histogram.

FIGS. 9A-9C show one example of edge detection and edge length filtering. Specifically, FIG. 9A shows a source image on which edge detection is to be performed.

FIG. 9B shows an edge map without edge length filtering. FIG. 9C shows an edge map with edge length filtering.

FIG. 10 shows an embodiment of a deblocking filter parameter selection process.

FIG. 11 shows an embodiment of a multi-scale search for deblocking filter parameter search and selection.

FIG. 12 shows an embodiment of a deblocking filter parameter search process at one scale level.

FIG. 13 shows a deblocking parameter space at two scale levels.

FIG. 14 shows an example where a deblocking filter parameter is located at a boundary case at scale level 0.

FIG. 15 shows a spiral search order for searching and selecting of deblocking filter parameters.

### DESCRIPTION OF EXAMPLE EMBODIMENTS

According to a first aspect of the disclosure, a method for selection of an optimal deblocking parameter associated with an optimal deblocking filter is provided, where the optimal deblocking filter is configured to be applied to a particular region in an image. The method comprises: providing an present input image, wherein the present input image is adapted to be partitioned into regions; providing a plurality of deblocking parameters, wherein each deblocking parameter is associated with a deblocking filter; generating a present coded image based on the present input image; selecting one deblocking parameter from the plurality of deblocking parameters; applying the deblocking filter associated with the selected deblocking parameter on a particular region in the present coded image to obtain present deblocked data; evaluating distortion associated with the selected deblocking parameter based on a difference between the present deblocked data and a corresponding region in the present input image; and iteratively performing the selecting, applying, and evaluating on some or all of the remaining deblocking parameters in the plurality of deblocking parameters, wherein the optimal deblocking parameter associated with the optimal deblocking filter is selected from among the selected deblocking parameters based on distortion evaluated for each selected deblocking parameter.

According to a second aspect of the disclosure, a method for selection of an optimal deblocking parameter associated with an optimal deblocking filter is provided, where the optimal deblocking filter is configured to be applied to a particular region in an image. The method comprises: providing an present input image, wherein the present input image is adapted to be partitioned into regions; providing a plurality of deblocking parameters, wherein each deblocking parameter is associated with a deblocking filter; generating a present coded image based on the present input image; determining a starting search center, wherein the starting search center is associated with a deblocking parameter among the plurality of deblocking parameters; determining a search range, wherein the search range determines number of deblocking parameters in the plurality of deblocking parameters around the starting search center to select; selecting one deblocking parameter among the plurality of deblocking parameters within the search range around the starting search center; applying the deblocking filter associated with the selected deblocking parameter on a particular region in the present coded image to obtain present deblocked data; evaluating distortion associated with the selected deblocking parameter based on a difference between the present deblocked data and a corresponding region in the present input image; and iteratively performing the selecting, applying, and evaluating on some or all of the remaining deblocking parameters within the search range around the starting search center, wherein the optimal deblocking parameter associated with the optimal deblocking filter is selected from among the selected deblocking parameters based on distortion evaluated for each selected deblocking parameter.

According to a third aspect of the disclosure, an encoder configured to perform deblocking filtering on image data based on deblocking parameters is provided. The encoder comprises: a reference picture buffer containing reference image data; a motion estimation and mode selection unit configured to generate prediction parameters based on input image data and the reference image data; a predictor unit configured to generate predicted image data based on the prediction parameters; a subtraction unit configured to take a difference between the input image data and the predicted image data to obtain residual information; a transformation unit and quantization unit configured to receive the residual information and configured to perform a transformation and quantization of the residual information; an inverse quantization unit and an inverse transformation unit configured to receive an output of the quantization unit and configured to perform inverse transformation and quantization on the output of the quantization unit; an adder configured to sum the output of the inverse transformation unit and the predicted image data to obtain combined image data; and a deblocking filtering unit configured to receive the combined image data and configured to perform deblocking on the combined image data based on the deblocking parameters, wherein an output of the deblocking filtering unit is adapted to be stored in the reference picture buffer. The encoder can utilize deblocking parameters obtained by performing the method in accordance with the first or second aspect of the disclosure.

Systems and methods for decoding bitstreams encoded by an encoder in accordance with the third aspect of the disclosure are also provided.

As used in this disclosure, the terms “picture”, “image”, and “frame” are used interchangeably. It should be noted that various processes of the present disclosure can be applied at the image level (also referred to as picture level or frame level) as well as on individual pixel or pixels within a picture. Specifically, the processes to be discussed in this disclosure can be applied to regions, slices, macroblocks, blocks, pixels, or otherwise any defined coding unit within a picture. Consequently, for purposes of discussion, the terms “picture”, “image”, and “frame” can also refer to regions, slices, macroblocks (e.g., 4×4, 8×8, 16×16), blocks, pixels, or otherwise any defined coding unit within a picture.

As used in this disclosure, the terms “region”, “slice”, and “partition” are used interchangeably and are defined herein to be any portion of a picture under consideration. An exemplary method of segmenting a picture into regions, which can be of any shape, takes into consideration image characteristics. For example, a region within a picture can be a portion of the picture that contains similar image characteristics. Specifically, a region can be one or more macroblocks, blocks, or pixels within a picture that contains the same or similar chroma information, luma information, and so forth. The region can also be an entire picture. As an example, a single region can encompass an entire picture when the picture in its entirety is of one color or essentially one color.

As used in this disclosure, the term “quality” refers to both objective video quality and subjective video quality. Objective video quality generally can be quantified. Examples of measures of (objective) video quality include distortion between an expected image and a predicted image, signal-to-noise ratio (SNR) of an image signal, peak signal-to-noise ratio (PSNR) of an image signal, and so forth.

Subjective video quality refers to the quality of the image as seen by a viewer of the image. Although subjective video quality can also be measured using objective measures of video quality, an increase in objective video quality does not necessarily yield an increase in subjective video quality, and vice versa. In relation to images processed using block-based operations, for instance, subjective video quality considerations can involve determining how to process pixels along block boundaries such that perception of block artifacts are reduced in a final displayed image. To an observer of an image, subjective quality measurements are made based on evaluating features such as, but not limited to, similarity with original pictures, smoothness, sharpness, details, and temporal continuity of various features in the image such as motion and luminance.

As used in this disclosure, the term “coding” refers to both encoding and decoding. Similarly, the terms “coded image” or “coded picture” refers to either or both of encoded image/picture and decoded image/picture.

### 1. Subjective-Based Post-Filter Optimization

Block-based video coding schemes are widely adopted in current video coding standards such as MPEG-4 and H264/MPEG-4 AVC (see reference [1], incorporated herein by reference in its entirety). One reason is that block-based video coding schemes can be adapted to be amenable to hardware implementation. In general, for instance, computational time/power and memory involved in the hardware implementation of many block-based video coding schemes can be adjusted to reasonable levels for a given application under consideration.

However, block-based video coding schemes can also introduce blocking artifacts in coded (e.g., encoded or decoded) images due to block-based operations such as block-based motion estimation, motion compensation, transformation, and quantization operations performed on images provided as input to an encoder. It should be noted that in cases where transmission errors occur in a bitstream generated by the encoder and transmitted to the decoder, the decoder may introduce blocking artifacts as a result of a difference between the bitstream generated by the encoder and actual bitstream received by the decoder.

As a result of these block-based operations and/or transmission errors, continuity of pixel information along block boundaries can be distorted and thus the block boundaries can lose continuity of pixel information, potentially degrading visual quality of resulting images subsequent to image reconstruction processes. The distortion along block boundaries can affect any edge information that may be present at pixels along these block boundaries. For instance, edge continuity between blocks can be distorted, and this distortion along the edge may be observable in a displayed image. Such distortion at the block boundaries is referred to as “blocking artifacts” or “blockiness”.

Moreover, since these resulting images may be used as reference images for encoding or decoding subsequent image information at the encoder or the decoder, such distortion resulting from the blocking artifacts present in the reference images can propagate to the subsequent image information. Specifically, the coding of subsequent images is dependent on image information in the reference images. As an example, motion estimation and motion compensation may be performed on an image with consideration to information from the reference images, and thus the blocking artifacts present in the reference images can affect quality of the images predicted based on motion estimation and motion compensation.

As is known by a person skilled in the art, low frequency components of an image pertain to slowly varying features of an image such as a flat area and general shapes/orientations of objects in the image while high frequency components of the image pertain to abrupt/sharp features such as edges.

It should be noted that distortion due to blocking artifacts is proportional to bitrate, where the bitrate can refer to number of bits transmitted per image from an encoder to a decoder. The bitrate can also refer to number of bits per second. Tradeoff between bitrate and distortion can be quantified as a rate-distortion cost. In general, lower distortion (generally associated with improved video quality) involves higher bitrate, which is associated with more bits per image.

Consequently, at low bitrate ranges, coefficients associated with high frequency components are generally quantized to zero, thus reducing the number of bits per picture while generally increasing distortion due to information lost from compression. Reconstruction of the images for display and/or use as reference images is thus based on images with higher distortion, leading to higher distortion in the displayed and/or reference images. The displayed image will thus be of lower visual quality at low bitrate ranges. Information in the reference images can be utilized in coding subsequent images, thus propagating the distortion into the subsequent images.

What is considered a low bitrate as compared to a high bitrate is application dependent. For instance, for high definition (HD) 1080p resolution, a bitrate of less than 3 Mbps is generally considered a low bitrate given amount of information that needs to be transmitted in a short amount of time for the HD 1080p resolution. In contrast, resolutions associated with mobile applications (e.g., cellular applications) are generally lower, and an exemplary low bitrate would be a bitrate less than 100 kbps.

Throughout the present disclosure, it should be noted that although the terms “block-based”, “block boundaries”, and “blocking artifacts” are utilized, such terms also encompass randomly shaped and randomly sized regions in a picture. For example, the term “deblocking” can refer to reducing effect of blocking artifacts along block boundaries but can also refer to reducing effect of artifacts along boundaries between two or more regions in a picture.

By way of example and not of limitation, some exemplary video applications include DVD storage applications, broadcasting applications, and streaming applications. Specifications such as bitrate, visual quality, and compression performance are generally different for each video application.

For example, storage applications generally place more emphasis on compression performance at medium and high bitrates. Less emphasis is generally placed on decoding complexity since hardware decoding is less of an issue for storage applications than, for instance, for mobile applications. Specifically, with further reference to storage applications in relation to mobile applications, computation time and power consumption are generally not as constrained in storage applications as in mobile applications.

For broadcasting applications, deblocking is generally utilized to maintain sufficient visual quality since transmission occurs at medium bitrates and thus distortion from blocking artifacts due to compression may be noticeable.

For streaming applications, specifications can vary due to various network and client conditions. Since streaming applications are generally associated with low bitrates, deblocking is generally employed to reduce distortion and maintain sufficient visual quality. Furthermore, if clients are utilizing portable/mobile devices, which generally have limited computational resources, deblocking may be employed to reduce distortion with consideration to complexity of the deblocking process since computational resources may be limited.

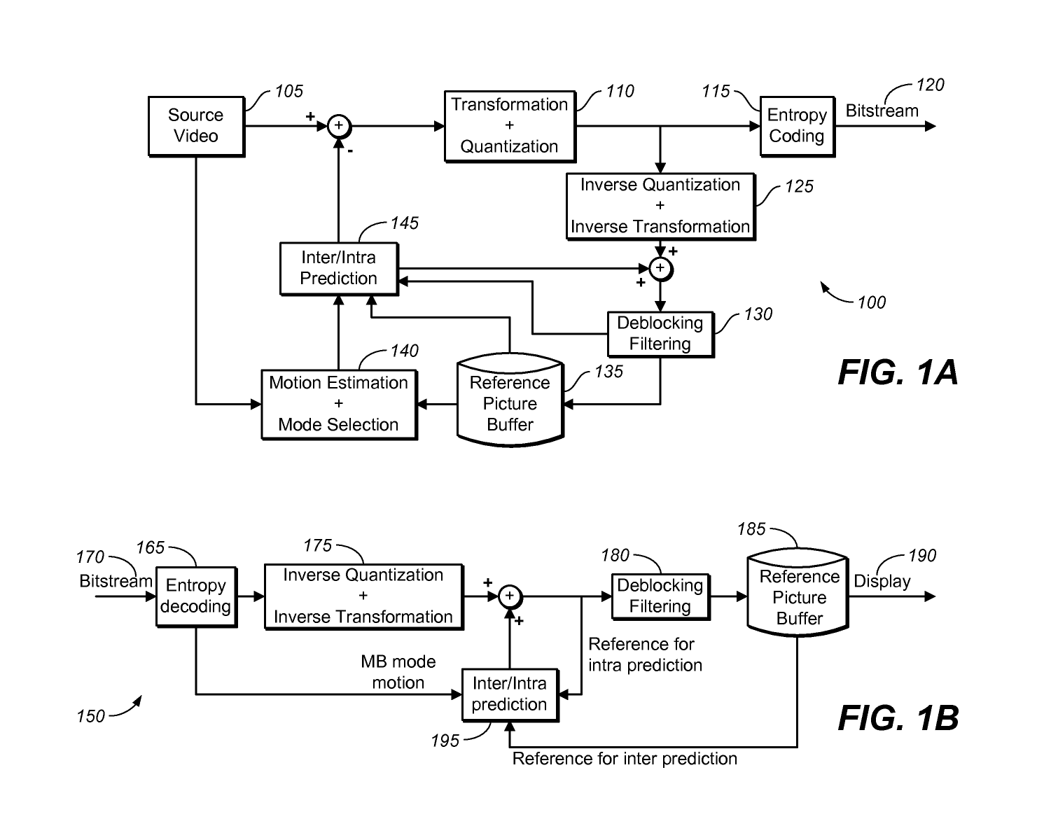

FIGS. 1A and 1B show exemplary implementations of a video encoder (100 in FIG. 1A) and video decoder (150 in FIG. 1B), respectively, where the video decoder (150) of FIG. 1B is adapted to receive information encoded by the video encoder (100) of FIG. 1A. At both the video encoder (100 in FIG. 1A) and video decoder (150 in FIG. 1B), blocking distortion can be reduced by way of deblocking filtering (130 in FIG. 1A, 180 in FIG. 1B) performed by a deblocking filter (130 in FIG. 1A, 180 in FIG. 1B).

With reference to FIG. 1A, the video encoder (100) is adapted to receive source video (105) comprising information pertaining to one or more images and is adapted to output a bitstream (120) comprising encoded information associated with the one or more images. The video encoder (100) may comprise various components, including but not limited to a motion estimation and mode selection module (140), a prediction module (145), forward transformation and quantization modules (110), inverse transformation and quantization modules (125), a deblocking filter (130), reference picture buffer (135), and an entropy coding module (115).

The motion estimation and mode selection module (140) performs operations such as mode selection/partition prediction type selection and motion/reference index estimation, weighted prediction parameter estimation, inter prediction, intra prediction, and so forth, which tries to determine from a set of possible prediction modes which mode is most appropriate and efficient to use for a particular application or given certain performance requirements (e.g., quality, bitrate, cost, complexity, and any combination thereof). Parameters generated by the motion estimation and mode selection module (140) are based on the source video (105) input to the encoder (100) and reference data from a reference picture buffer (135). The reference picture buffer (135), which is accessed and appropriately controlled for prediction purposes, generally contains previously reconstructed/coded samples/information in the form of reference pictures or regions of pictures.

With relation to mode selection in the motion estimation and mode selection module (140), the mode selection involves selection of a coding mode for each pixel or group of pixels (e.g., regions, blocks, and so forth). The coding mode can generally be an inter prediction or an intra prediction. Mode selection makes a determination as to which mode leads to higher coding efficiency and/or higher visual quality. The selected mode can be signaled to the decoder.

A prediction module (145), which, given parameters from the motion estimation and mode selection module (140) and previously reconstructed/coded samples/information, generates a prediction for a present picture or region thereof. The motion estimation and mode selection module (140) may signal the prediction module (145) to perform intra prediction or inter prediction.

Intra prediction is associated with utilizing spatial information within an image to perform the motion estimation and compensation to generate samples/information within the same image. Specifically, information for a previously coded pixel or group of pixels can be utilized in predicting a neighboring pixel or group of pixels. Consequently, intra prediction can also be referred to as spatial prediction. Intra prediction can be utilized to exploit spatial correlation and remove spatial redundancy that may be inherent in a video signal. Intra prediction may be performed on regions of various sizes and shapes. In block-based intra prediction, for instance, H.264/AVC allows block sizes of 4×4, 8×8, and 16×16 pixels for intra prediction of the luma component of the video signal and allows a block size of 8×8 pixels for intra prediction of the chroma components of the video signal.

Inter prediction is associated with using temporal information to perform the motion estimation and compensation. Specifically, reference data from a corresponding pixel or group of pixels in previously coded images in a video signal can be utilized in the prediction process of the pixel or group of pixels in a present image to be coded. Consequently, inter prediction can also be referred to as temporal prediction. Inter prediction can be utilized to exploit temporal correlation and remove temporal redundancy that may be inherent in a video signal. Similar to block-based intra prediction, in block-based inter prediction, H.264/AVC allows block sizes of 4×4, 4×8, 8×4, 8×8, 8×16, 16×8, and 16×16 pixels for inter prediction of the luma component of the video signal.

The forward transformation and quantization (110) and inverse transformation and quantization (125) modules, which are used to encode any residual/error information that may remain after prediction. By way of example, transformations may include a discrete cosine transform, Hadamard transform, Fourier transform, as well as other transformations identifiable by a person skilled in the art.

The deblocking filter (130), also referred to as loop filtering or in-loop filtering, can be utilized for performing additional processing/filtering after reconstruction of image information to reduce blocking artifacts and improve subjective (primarily) and objective quality.

The entropy coding module (115) can be utilized to losslessly compress various information involved in reconstructing the image information including but not limited to transformed and quantized residual information, motion estimation information, transformation and quantization parameters, deblocking filter parameters, header information, and so forth. Transformation parameters can include type of transformation utilized. Motion estimation information can include information on mode decisions, motion vectors, weighted prediction parameters, intra prediction parameters, reference data utilized (e.g., reference index associated with a utilized reference picture), and so forth. Header information generally specifies (in the case of encoded video information) image size, image resolution, file format, and so forth.

FIG. 1B shows an exemplary implementation of a video decoder (150) adapted to decode a bitstream (170) received from the video encoder (100) of FIG. 1A. The video decoder (150) has similar components to those found in the video encoder (100) of FIG. 1A. The video decoder can comprise, for instance, an entropy decoding module (165), inverse transformation and quantization modules (175), a deblocking filter (180), a reference picture buffer (185) for use in prediction, and a prediction module (195). An output of the deblocking filter (180) is adapted to be provided to a display (190) (e.g., computer screen, cellular phone screen, and so forth) and/or adapted to be stored in the reference picture buffer (185) for prediction (195) of subsequent images.

As shown in FIGS. 1A and 1B, a deblocking filter (130 in FIG. 1A, 180 in FIG. 1B) can be placed in the motion compensation loop to improve quality and coding efficiency. Specifically, a deblocked image from the deblocking filter (130 in FIG. 1A, 180 in FIG. 1B) can be stored in a reference picture buffer (135 in FIG. 1A, 185 in FIG. 1B) and used as a reference image for prediction of subsequent images. The deblocking process is generally performed pixel-by-pixel and thus involves computation capabilities.

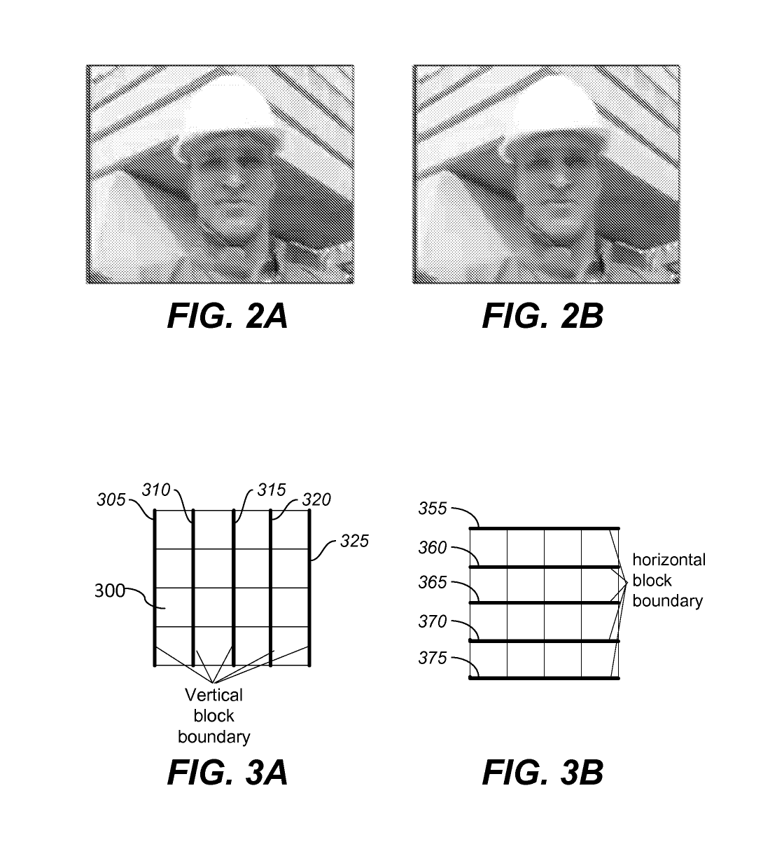

FIGS. 2A and 2B show a quality comparison of a particular image without and with deblocking filtering, respectively. Blocking artifacts, which generally affect subjective visual quality of an image, are more evident in FIG. 2A than in FIG. 2B. Specifically, visual quality perceived by a viewer of the particular image can be improved by filtering pixels along block boundaries as well as pixels neighboring those pixels along the block boundaries. Such filtering can generally be observed as a smoothing of features in an image. Alternatively or in addition, the deblocking filtering process can also be used in post-processing (subsequent to decoding) to reduce the blocking artifacts in images prior to displaying the images. The deblocking filtering process affects both pixels along block boundaries as well as pixels within a block.

It should be noted that objective quality of an image is not necessarily directly proportional to subjective quality of the image. An example of an objective measure of image quality is given by peak signal-to-noise ratio (PSNR), which provides a logarithmic ratio between square of maximum value of a pixel within the image and a mean square error between two images (e.g., an original image and a processed image corresponding to the original image). It should be noted that noise includes various distortions including but not limited to white noise, distortion associated with blocking artifacts, quantization errors, and so forth. In an eight bit case, for instance, a pixel can contain values [0, 255] and thus the maximum value of the pixel is 255. In terms of PSNR, a higher PSNR is associated with a smaller difference between the two images, which in turn means that the compression yields a good approximation of the original image. Consequently, a higher PSNR is generally associated with higher (objective) image quality.

As previously mentioned, the objective measure provides only an approximation of human perception of the image quality, also referred to as subjective image quality. For example, in some cases, a first deblocked image has a lower PSNR than a second deblocked image. The first deblocked image can have, however, better edge continuity than the second deblocked image. As a result, a person viewing the first deblocked image may be of the opinion that the first deblocked image is of higher image quality than the second deblocked image.

FIGS. 3A and 3B each show a 16×16 macroblock, where each block (300) in the 16×16 macroblock contains 4×4 pixels. FIG. 3A illustrates vertical block boundaries (305, 310, 315, 320, 325) while FIG. 3B illustrates horizontal block boundaries (355, 360, 365, 370, 375).

In FIG. 3A, the vertical block boundaries (305, 310, 315, 320, 325) of each block are taken, arbitrarily, as the column of pixels along the leftmost portion of the block. In FIG. 3B, the horizontal block boundaries (355, 360, 365, 370, 375) of each block are taken, arbitrarily, as the row of pixels along the topmost portion of the block. Other columns and rows of pixels (such as those along the rightmost row or bottommost portion of the block) can be designated as the vertical and horizontal block boundaries, respectively. It should be noted that, as shown in FIGS. 3A and 3B, the rightmost block boundary (325 in FIG. 3A) and the bottommost horizontal block boundary (375 in FIG. 3B) are considered block boundaries of blocks of an adjacent macroblock (not shown).

Although not shown in FIGS. 3A and 3B, it should be noted that each block boundary may (but need not) include both luma and chroma components. By way of example and with reference to FIG. 3A, each vertical block boundary (305, 310, 315, 320, 325) may contain a luma component whereas only alternating block boundaries (305, 315, 325) contain chroma components. Similarly, in FIG. 3B, each horizontal block boundary (355, 360, 365, 370, 375) may contain a luma component whereas only alternating horizontal block boundaries (355, 365, 375) contain chroma components. In this case, at the pixel level, chroma resolution is one-fourth that of the luma resolution. As is known by a person skilled in the art, H.264 4:2:0 compression is an exemplary compression standard that provides this particular ratio of luma to chroma resolution. However, such a luma to chroma resolution is exemplary and other resolutions can be implemented.

In general, similar to that shown in FIGS. 3A and 3B, a macroblock comprises 16×16 pixels. Exemplary block sizes within a particular macroblock can be a grouping of 4×4 or 8×8 pixels. A block size can also be 1×1, in which case the term “block” and the term “pixel” can be used interchangeably. Other block sizes and macroblock sizes can be used. Also, as previously noted, arbitrarily shaped regions may also be defined within an image or within a block/macroblock. To reduce blocking distortion, a deblocking filter can be adopted for every block boundary. The deblocking filter can apply a one dimensional filter to each of a vertical and a horizontal direction at the block boundaries. Each block can have its own set of deblocking parameters.

FIGS. 3A and 3B show block sizes of 4×4 pixels. Consequently, quantization, transformation, deblocking, and motion estimation/compensation are adapted to be performed for blocks of this size. If the block sizes were to change to 8×8 pixels, then quantization, transformation, deblocking, and motion estimation/compensation are adapted to be performed for blocks of 8×8 pixels.

For a particular block, filter strength can be determined based on pixel values at its block boundaries as well as pixel values in neighboring blocks of the particular block. A high (or strong) filter strength refers to filtering that greatly affects pixel values whereas a low (or weak) filter strength refers to filtering that leaves the pixel values relatively unaffected relative to prior to filtering. In terms of deblocking filters, deblocking filters of high strength can be applied to pixels along the block boundaries to smooth the pixel values across the block boundaries and thus reduce blocking artifacts. Deblocking filters of low strength are generally applied to pixels away from the block boundaries, where blocking artifacts are generally low.

In the case that a block and its adjacent block are associated with a similar motion vector, then a weak deblocking filter can generally be used. Specifically, if motion vectors of adjacent blocks are similar, motion compensated (also referred to as motion predicted) pixels are also similar between adjacent blocks. The similar pixels in adjacent blocks are generally associated with low block artifacts and thus a weak deblocking filter can be utilized. Similarly, if the motion vectors are different between blocks, then a strong deblocking filter can generally be utilized. In H.264 coding, for instance, five levels of filter strength are provided. It should be noted that a function between motion vector and filter strength can be nonlinear and that filter strength is a function of various other factors as well. The filter strength can be a function of whether or not a block is intra or inter coded and whether or not there is residual coding within the block. For instance, if the block is an intra coded block, then the filter strength is generally large (strong filtering) since blocking artifacts are generally more visually obvious at intra block boundaries than at inter block boundaries. If there are no residuals to encode for a particular block, then deblocking filtering may not need to be performed since the particular block consists of predictions from a previous filtered picture.

The deblocking process involves a determination of whether or not a deblocking filter should be applied to a particular block boundary and, in the case that a deblocking filter should be applied to the particular block boundary, a determination of deblocking filter parameters to be applied to each pixel along the particular block boundary. Improvement of overall coding performance (relative to a case where no deblocking is performed) involves selection of which block boundaries to apply deblocking and actual filtering parameters to be applied to the block boundaries on which deblocking should be applied. Deblocked data (e.g., deblocked images or deblocked regions) can be stored in a reference picture buffer for use in coding of subsequent images or regions thereof. Deblocking filter parameters obtained by an encoder can be signaled to a decoder such that the decoder utilizes these signaled deblocking filter parameters.

It should be noted that in some cases (see references [4] and [5], incorporated herein by reference in their entirety), deblocking filters and their associated deblocking parameters are taken into consideration primarily (or solely) on the decoder side subsequent to decoding of an image and prior to display. Specifically, the deblocking filters can be applied in a post-processing stage, such as subsequent to decoding at the decoder side. Optimization of the deblocking filters at the post-processing stage can be utilized to smooth block boundaries. In these cases where deblocking is performed subsequent to decoding and prior to displaying, optimization of the deblocking filter is generally not performed at the encoder side (e.g., default deblocking parameters may be applied at both the encoder side and the decoder side or no deblocking is applied until just prior to displaying).

According to many embodiments of the present disclosure, rate-distortion optimization methods (see, for example, reference [2], incorporated herein by reference in its entirety) are utilized in deblocking filter parameter selection criteria. In general, trade-offs between different metrics can be quantified according to requirements involved in different video applications. Specifically, the deblocking filter parameter selection is performed with consideration to visual quality and computational complexity.

In this disclosure, a metric for deblocking parameter selection is provided in the general case, which can then be adjusted based on different applications. Fast deblocking parameter selection methods are also provided.

According to many embodiments of the present disclosure, a metric for deblocking parameter selection in a general case is provided by equation (1) below:

D(p)=D(Fⁿ,Oⁿ,Oⁿ⁺¹)+λᵣ×r(p)+λ_{b}×B(Fⁿ)+λₑ×EC(Fⁿ)+λ_{d}<Complexity(DB(p,Rⁿ)) (1)

Generally, a solution to equation (1) involves selecting (e.g., solving for) deblocking parameter p such that D(p) is a minimum among all evaluated p or otherwise sufficiently low for a given application. For instance, a fast search method may select a sub-optimal parameter p that provides a D(p) within a set range. Although quality of deblocked data obtained based on applying the sub-optimal parameter p can be lower relative to deblocked data that can be obtained based on applying an optimal p, a lower complexity and lower computational cost are generally associated with the fast search method. In general, a deblocking parameter p is selected for each region (e.g., slices, block or groups of blocks) of an image, and this deblocking parameter p can be applied to all pixels that define the region. The deblocking parameter p can be utilized to determine whether or not a particular pixel needs to be deblocked.

A definition of each parameter is provided in Table 1:

TABLE 1
Parameters definitions in equation (1)

| Index | Definition |
|---|---|
| Rⁿ | n-th reconstructed picture |
| Oⁿ | n-th original picture |
| Fⁿ | n-th deblocked picture (output of deblocking |
| | process DB(p, Rⁿ)) |
| p | deblocking parameters |
| r(p) | rates used to signal deblocking parameters |
| λᵣ | scaling factor for rates to signal deblocking |
| | parameters |
| λ_{b} | scaling factor for blocking distortion |
| | measurement at block boundaries |
| λₑ | scaling factor for edge continuity distortion |
| | measurement |
| λ_{c} | scaling factor for complexity of deblocking |
| | process |
| D(p) | total distortion of deblocking parameters p |
| DB(p, Rⁿ) | deblocking process of applying deblocking |
| | parameters p on a picture Rⁿ |
| D(Fⁿ, Oⁿ, O^{n + 1}) | distortion between deblocked picture and |
| | original picture |
| B(Fⁿ) | block distortion at block boundaries |
| EC(Fⁿ) | edge continuity distortion based on edge pixels |
| | at block boundaries |
| Complexity(DB(p, Rⁿ)) | complexity of deblocking process |

As shown in equation (1), the distortion metric D(p) has five components in the general case. Specifically, the distortion metric D(p) can be decomposed into D(Fⁿ, Oⁿ, Oⁿ⁺¹), r(p), B(Fⁿ), EC(Fⁿ), and Complexity(DB(p, Rⁿ)), where the latter four have corresponding scaling factors λᵣ, λ_{b}, λₑ, and λ_{c}, respectively. The variable n is an arbitrary discrete moment in time, where n is generally an integer for simplicity, that is followed by discrete time n+1.

The first component in equation (1), D(Fⁿ, Oⁿ, Oⁿ⁺¹), provides a measure of distortion between an original image and a deblocked image. Specifically, D(Fⁿ, Oⁿ, Oⁿ⁺¹) is a function of an n-th original image Oⁿ, an n-th deblocked image Fⁿ associated with the n-th original image Oⁿ, and an (n+1)-th original image Oⁿ⁺¹. The distortion between these three images can be given by equation (2) below:

$$D ( {F}^{n} , {O}^{n} , {O}^{n + 1} ) = {\sum }_{( x , y ) ∈ picture and \\ ( x , y ) ∉ block boundaries}^{ } Distortion ( {F}_{x , y}^{n} - {O}_{x , y}^{n} ) + β \times {\sum }_{( x , y ) ∈ picture}^{ } Distortion ( {O}_{x , y}^{n + 1} - MC ( {F}^{n} , {MV}_{x , y} ) ) \qquad ( 2 )$$

By way of example and not of limitation, the distortion metric, referred to in equation (2) as Distortion, can be a sum of squared error (SSE), sum of differences (SAD), sum of squared differences (SSD), sum of absolute transformed differences (SATD), structural similarity (SSIM), and so forth.

The first component of equation (2)

$${\sum }_{( x , y ) ∈ picture and \\ ( x , y ) ∉ block boundaries}^{ } Distortion ( {F}_{x , y}^{n} - {O}_{x , y}^{n} ) \qquad ( 2.1 )$$

determines a sum of distortion between corresponding pixels (x, y) of the past original picture Oⁿ and the past deblocked picture r associated with Oⁿ, denoted as O_{x,y}ⁿ and F_{x,y}ⁿ, respectively. However, this sum relates to distortion pertaining to pixels away from the block boundaries.

The second component of equation (2) is given by

$$β \times {\sum }_{( x , y ) ∈ picture}^{ } Distortion ( {O}_{x , y}^{n + 1} - MC ( {F}^{n} , {MV}_{x , y} ) ) \qquad ( 2.2 )$$

where MC refers to motion compensation and MV_{x,y} refers to a motion vector at pixel (x, y). The second component determines a sum of distortion between corresponding pixels of the (n+1)-th original image Oⁿ⁺¹ and a prediction of the (n+1)-th original image MC(Fⁿ, MV_{x,y}). A weight β, which can be any real number, is set based on application. It should be noted that O_{x,y}ⁿ⁺²−MC(Fⁿ, MV_{x,y}) provides a measure of coding efficiency, since a small difference (residual) between Oⁿ⁺¹ and its prediction MC(Fⁿ, MV) is associated with fewer bits to transmit to a decoder whereas a large difference (residual) is associated with more bits. Furthermore, O_{x,y}ⁿ⁺¹−MC(Fⁿ, MV_{x,y}) provides a measure of effect of a past deblocking process (e.g., associated with Fⁿ) on coding of a present picture (e.g., Oⁿ⁺¹). The weight β can be selected based on relative importance of this aspect of coding efficiency in relation to selection of the deblocking parameters p compared to various other components in equation (1) above.

It should be noted that Fⁿ is being used as a reference picture on which to predict the (n+1)-th original image Oⁿ⁺¹. Specifically, motion estimation and compensation can be performed on the deblocked image r to obtain a prediction of Oⁿ⁺¹. For example, if a pixel (x, y) in Oⁿ⁺¹ corresponds with a pixel (x+1, y) for the past deblocked picture Fⁿ, then the motion vector MV relating to pixel (x, y) is (1, 0). The second component of equation (2) takes into account dependency on r in coding of subsequent images.

The second component in equation (1), λᵣ×r(p), provides a rate cost for encoding deblocking parameters p. Specifically, r(p) is the number of bits associated with encoding information pertaining to p for each picture or each block in a picture, and thus yields an overhead on transmission of video information. A weight λᵣ provides a measure of relative importance of rate cost consideration (in relation to the other components of equation (1)) in selecting the deblocking parameters p.

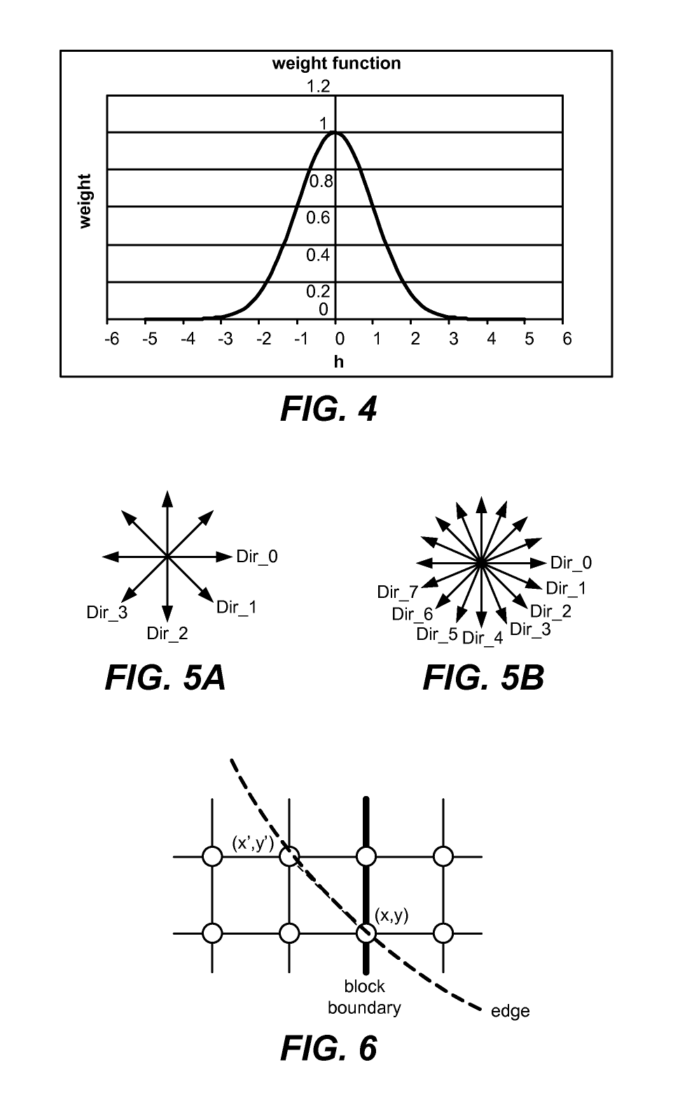

The third component in equation (1), λ_{b}×B(Fⁿ), provides blocking distortion measurement at block boundaries and can be given as follows

$$B ( {F}^{n} ) = α \times {\sum }_{( x , y ) ∈ block boundaries}^{ } Distortion ( {F}_{x , y}^{n} - {O}_{x , y}^{n} ) + {\sum }_{\begin{matrix}( x , y ) , ( x - 1 , y ) ∈ vertical block boundaries \\ and ( x , y ) ∉ edges\end{matrix}}^{ } w ( {F}_{x , y}^{n} - {F}_{x - 1 , y}^{n} ) \times Distortion ( {F}_{x , y}^{n} - {F}_{x - 1 , y}^{n} ) + {\sum }_{\begin{matrix}( x , y ) , ( x - 1 , y ) ∈ horizontal block boundaries \\ and ( x , y ) ∉ edges\end{matrix}}^{ } w ( {F}_{x , y}^{n} - {F}_{x , y - 1}^{n} ) \times Distortion ( {F}_{x , y}^{n} - {F}_{x , y - 1}^{n} ) \qquad ( 3 )$$

where w(h) is a weight function. A weight function is generally utilized to give some values h more weight than other values of h. An exemplary weight function can be given by a Gaussian-shaped function w(h)=exp[−h²/(2σ²)], as shown in FIG. 4, and will be described in more detail later in the disclosure. Depending on a particular imaging application, other weight functions that follow distributions such as Lorentzian, Laplace, and uniform distributions may also be utilized. A weight λ_{b} provides a measure of relative importance of considering blocking distortion at block boundaries (in relation to the other components of equation (1)) in selecting the deblocking parameters p.

The first component of equation (3) is given by

$$α \times {\sum }_{( x , y ) ∈ block boundaries}^{ } Distortion ( {F}_{x , y}^{n} - {O}_{x , y}^{n} ) \qquad ( 3.1 )$$

which provides a measure of distortion between O_{x,y}ⁿ and F_{x,y}ⁿ, where the pixels (x, y) are those pixels along the block boundaries. Specifically, such distortion is between a processed pixel after deblocking, given by F_{x,y}ⁿ, and the original pixel, given by O_{x,y}ⁿ. A weight a, which can be any real number, is selected based on relative importance of this aspect in relation to selection of the deblocking parameters p compared to various other components in equations (1) and (3) above.

The second component of equation (3) is given by

$${\sum }_{\begin{matrix}( x , y ) , ( x - 1 , y ) ∈ vertical block boundaries \\ and ( x , y ) ∉ edges\end{matrix}}^{ } w ( {F}_{x , y}^{n} - {F}_{x - 1 , y}^{n} ) \times Distortion ( {F}_{x , y}^{n} - {F}_{x - 1 , y}^{n} ) \qquad ( 3.2 )$$

which provides a measure of distortion between a particular pixel (x, y) at a vertical block boundary and a neighboring pixel (x−1, y) on the left of the particular pixel (x, y). Additionally, the pixels along the vertical block boundaries do not include those pixels containing edges. Another aspect of equation (1) will take into consideration the edges. Specifically, equation (3.2) provides a measure of smoothness along vertical block boundaries. The neighboring pixel being on the left of the particular pixel along a vertical block boundary is shown in FIG. 3A. It should be noted that the neighboring pixel can be on the right of the particular pixel (x, y). In such a case, equation (3.2) would be adjusted such that each incidence of pixels (x−1, y) is replaced with (x+1, y).

Alternatively or in addition, other neighboring pixels can also be taken into consideration. For example, with repeated reference to regions composed of blocks (such as that shown in FIG. 3A), a combination of distortion between a particular pixel (x, y) at a vertical block boundary and its two neighboring pixels on the right or on the left (or one neighboring pixel on the right and another neighboring pixel on the left) can be obtained. Additional neighboring pixels can also be considered.

The third component of equation (3) is similar to equation (3.2) above and is given by

$${\sum }_{\begin{matrix}( x , y ) , ( x - 1 , y ) ∈ horizontal block boundaries \\ and ( x , y ) ∉ edges\end{matrix}}^{ } w ( {F}_{x , y}^{n} - {F}_{x , y - 1}^{n} ) \times Distortion ( {F}_{x , y}^{n} - {F}_{x , y - 1}^{n} ) \qquad ( 3.3 )$$

which provides a measure of difference in values between a particular pixel (x, y) at a horizontal block boundary and a neighboring pixel (x, y−1) above the particular pixel (x, y). Similar to equation (3.2), the pixels along the horizontal block boundaries do not include those pixels containing edges. Equation (3.3) provides a measure of smoothness along horizontal block boundaries. The neighboring pixel being on the top of the particular pixel at a horizontal block boundary is shown in FIG. 3B. Other or additional neighboring pixels can be considered when calculating the difference measure between the particular pixel and its neighbors. For instance, the neighboring pixel can be below the particular pixel (x, y). In such a case, equation (3.3) would be adjusted such that each incidence of pixels (x, y−1) is replaced with (x, y+1).

For discussion purposes, the weight function is shown in FIG. 4 and given as w(h)=exp[−h²/(2σ²)]. With regards to application of the weight function w(h), the variable h in equations (3.2) and (3.3) above is a difference between values at a particular pixel (e.g., F_{x,y}ⁿ) and its neighboring pixel or pixels (e.g., F_{x,y-1}ⁿ). Variance σ² provides a spread of h in a given picture.

When the difference between values at the particular pixel and the neighboring pixel or pixels is small, h is small, w(h) is close to unity, and Distortion(h) is small. The product w(h)×Distortion(h) is small and thus the contribution of equation (3.2) and/or (3.3) to blocking artifacts is also small.

When the difference between values at the particular pixel and the neighboring pixel or pixels is large, h is large, w(h) is close to zero, and Distortion(h) is large. The product w(h)×Distortion(h) is small and thus the contribution of that particular pixel to blocking artifacts should also be small. A reason that a large difference between the particular pixel and its neighboring pixel or pixels needs not be associated with large values for equation (3.2) and/or (3.3), and thus needs not contribute significantly to equation (3) is provided as follows. A large difference between the particular pixel and its neighboring pixel or pixels provides an indication that the picture may have an abrupt change in values and thus the distortion is not necessarily a result of compression (e.g., blocking artifacts resulting from compression). Instead, the large difference may be a result of abrupt changes present in the original picture. In such a case, the large difference would not contribute significantly to deblocking parameter selection as defined in equation (1).

The fourth component in equation (1), λₑ×EC(Fⁿ), provides a measure of edge continuity distortion at block boundaries and can be given as follows:

$$EC ( {F}^{n} ) = {\sum }_{\begin{matrix}( x , y ) ∈ block boundaries \\ and ( x , y ) ∈ edges\end{matrix}}^{ } Distortion ( {F}_{x , y}^{n} - {F}_{{x}^{′} , {y}^{′}}^{n} ) . \qquad ( 4 )$$

The edge continuity distortion at block boundaries provides a difference between a particular pixel (x, y) in a past deblocked picture Fⁿ and a neighboring pixel (x′, y′) in the past deblocked picture Fⁿ along an edge direction from the particular pixel (x, y). Specifically, equation (4) considers edges at block boundaries and provides a measure of how much distortion is introduced in the edges due to deblocking. In the case that an edge is continuous, F_{x,y}ⁿ=F_{x′,y′}ⁿ. If all edges along block boundaries are essentially continuous (e.g., pixels of edges along block boundaries are equal or close to equal), then EC(Fⁿ)≈0. A weight λₑ provides a measure of relative importance of considering blocking distortion introduced by edges along block boundaries (in relation to the other components of equation (1)) in selecting the deblocking parameters p.

The edge continuity distortion can involve use of salient edge detection to detect edges in a picture. Specifically, detection of edges involves determining whether a particular difference constitutes an edge. To reduce complexity, edge detection is generally discretized (i.e., quantized) into specific directions or angles. With reference to the encoder (100) of FIG. 1A, the deblocking filter (130) can include an edge detector. In the decoder (150) of FIG. 1B, the deblocking filter (180) can include an edge detector but can also decode deblocking parameters from the bitstream (170) received from an encoder. The edge detection is generally performed on images of the source video (105).

FIGS. 5A and 5B show exemplary edge direction discretization in four and eight directions, respectively. FIG. 6 shows an example of a block boundary that contains an edge. To determine pixel (x′, y′), an edge detector obtains the direction of the edge from pixel (x, y), where the pixel (x, y) is along a block boundary. With reference to FIGS. 5A, 5B, and 6, a direction associated with (x′, y′) and (x, y) in FIG. 6 would be Dir_{—}1 in FIG. 5A and Dir_{—}2 in FIG. 5B.

The fifth component of equation (1), λ_{c}×Complexity(DB(p, Rⁿ)), provides a measure of deblocking filter complexity. Application of deblocking on reconstructed data Rⁿ utilizing deblocking parameter p to obtain Fⁿ is denoted as DB(p, Rⁿ). The complexity of the deblocking process can be measured by time or processor's cycles involved in applying the deblocking filter. A weight λ_{c} determines relative importance of complexity (e.g., computation time) involved in performing the deblocking process.

Optimal deblocking parameters p are generally defined as those that will generate the best trade-off from some or all aspects of D(p) provided in equation (1) with respect to an application. As previously stated, other search methods, including fast search methods, may be utilized to select a sub-optimal parameter p that provides D(p) within a set range.

According to an embodiment of the present disclosure, the metric D(p) provided in equation (1) above can be adjusted depending on application. For example, consider an application with an encoder/decoder pair where the decoder does not take into consideration deblocking complexity but focuses on compression performance. Additionally, the bitrate is taken into consideration and the encoder/decoder pair can transmit at bitrates above medium bitrates. However, above medium bitrates, blocking artifacts are generally low and thus consideration for blocking artifacts along block boundaries and edge continuity distortion are negligible. As a result, λ_{b}, λₑ, and λ_{c} in equation (1) can be set to 0. The following equation results:

$$D ( p ) = D ( {F}^{n} , {O}^{n} , {O}^{n + 1} ) + {λ}_{r} \times r ( p ) = {\sum }_{( x , y ) ∈ picture}^{ } Distortion ( {F}_{x , y}^{n} - {O}_{x , y}^{n} ) + β \times {\sum }_{( x , y ) ∈ picture}^{ } Distortion ( {O}_{x , y}^{n + 1} - MC ( {F}^{n} , {MV}_{x , y} ) ) + {λ}_{r} \times r ( p ) . \qquad ( 5 )$$

Specifically, in such a case, the metric D(p) takes into consideration distortion between the reference deblocked picture F_{x,y}ⁿ and the corresponding original picture O_{x,y}ⁿ, distortion between the present original picture O_{x,y}ⁿ⁺¹ and a prediction MC(Fⁿ, MV_{x,y}) of the present picture, and the compression performance. In this case, optimal deblocking parameters p are selected based on equation (5). It should be noted that if Fⁿ is not a reference picture or is not referenced by (n+1)-th image, then β will be set to zero.

For some applications, system computation capability is sufficient to handle the decoding process because of hardware acceleration or processors with multiple cores. Examples of applications that generally involve these traits include broadcasting and video on demand via broadband network. As a result, λ_{c} can be set to zero since complexity may be less of a concern relative to the other considerations provided in equation (1).

In some systems, edge detection capability is not present. An exemplary system that is generally without edge detection is a live encoding system. In such cases, edge continuity distortion cannot be taken into consideration and thus λₑ is set to zero. Generally in these cases, all pixels are considered non-edge pixels and thus equation (4) is zero. In such a case, equation (1) is simplified:

D(p)=D(Fⁿ,Oⁿ,Oⁿ⁺¹)+λᵣ×r(p)+λ_{b}×B(Fⁿ)+λ_{c}×Complexity(DB(p,Rⁿ)) (6)

where equation (3) becomes:

$$B ( {F}^{n} ) = α \times {\sum }_{( x , y ) ∈ block boundaries}^{ } Distortion ( {F}_{x , y}^{n} - {O}_{x , y}^{n} ) + {\sum }_{( x , y ) , ( x - 1 , y ) ∈ vertical block boundaries}^{ } w ( {F}_{x , y}^{n} - {F}_{x - 1 , y}^{n} ) \times Distortion ( {F}_{x , y}^{n} - {F}_{x - 1 , y}^{n} ) + {\sum }_{( x , y ) , ( x , y - 1 ) ∈ horizontal block boundaries}^{ } w ( {F}_{x , y}^{n} - {F}_{x , y - 1}^{n} ) \times Distortion ( {F}_{x , y}^{n} - {F}_{x , y - 1}^{n} ) . \qquad ( 7 )$$

As another example, streaming application is common and a higher number of mobile devices support video playback. Battery consumption is a concern in mobile devices, and video visual quality is also a concern because of low bitrate associated with mobile applications. In such cases, higher weights λ_{c} and λᵣ are generally assigned to complexity (e.g., computation power and time) and bitrate. Selection of parameter p is generally performed offline at the encoder side.

### 2. Salient Edge Detection

With reference to equation (4) above, edge continuity distortion measurement involves detecting edges based on gradient. Since an image can be analyzed from multiple channels, the gradient refers to changes in these channels. For instance, in addition to the luma channel (e.g., brightness), color channels such as red (R), green (G), and blue (B) channels can be taken into consideration. Edge detection can generally be performed for each channel separately. An edge in one channel is not necessarily an edge in another channel. As an example, although values in the luma channel can abruptly change (signifying an edge), the edge can have continuous values in its red channel. Other exemplary channels are channels associated with any color space, including RGB as provided above as well as CMYK (cyan, magenta, yellow, and black) and HSV (hue, saturation, and value).

Detection of an edge may be based on each channel separately. In this case, an edge may be detected if a set number of the channels detects an edge.

Detection of an edge may also be based on combining results from each channel (e.g., via a linear combination with different or same weights applied to each channel). The combination of edge detection information from each of these different channels can generate more accurate results than when edge detection is based on each channel separately. Relative to the case of edge detection for each channel separately, the combination is generally less affected by noise. The combination can be given by

Edge(x,y)=a₀ Edge(x(C₀),y(C₀))+a₁ Edge(x(C₁),y(C₁))+a₂ Edge(x(C₂),y(C₂)) (8)

where C₀, C₁, and C₂ are channels associated with each pixel (x, y). Each of Edge(x(Cᵢ), y(Cᵢ)) can be a binary value (e.g., 0 representing that the pixel is not an edge and 1 representing that the pixel is an edge). If Edge(x, y) is larger than some threshold, then pixel (x, y) is considered an edge. Weights a₀, a₁, and a₂ are generally set based on human subjective evaluation. For example, a human eye is generally more sensitive at its luminance (L) and green (G) channels, and thus weights associated with the L and G channels can be set higher than at red (R) and blue (B) channels of the human eye.

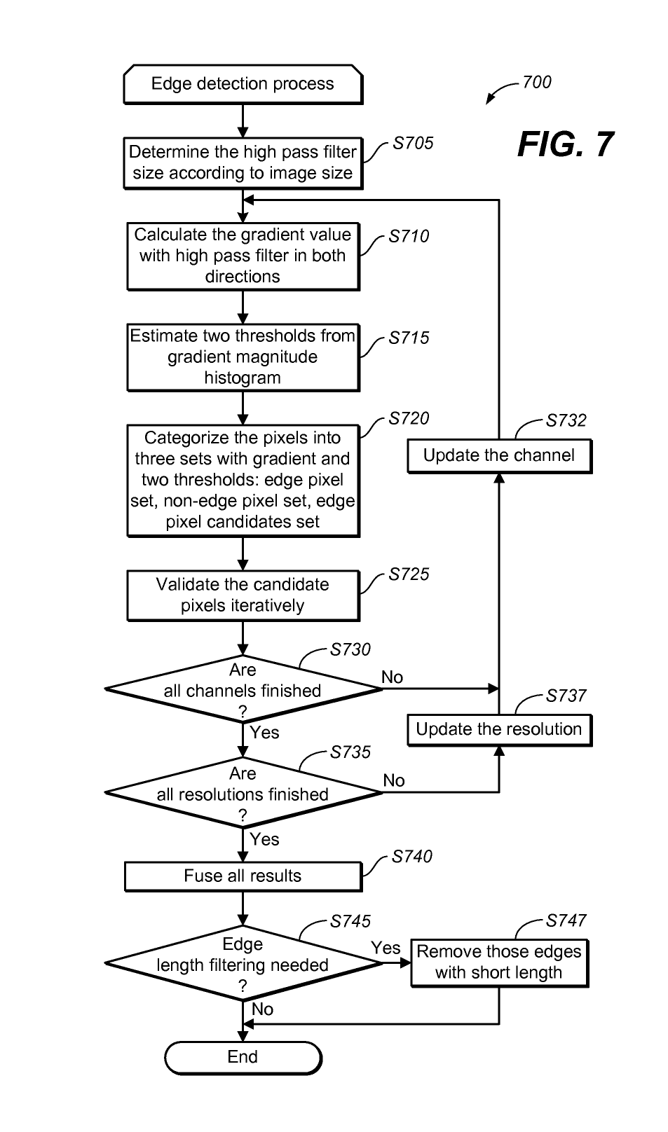

FIG. 7 shows a flowchart of an embodiment of an edge detection process (700). According to many embodiments of the present disclosure, an image can be downsampled into multiple resolutions. For instance, an edge that is smooth at higher resolutions of an image can become sharper and/or more abrupt (and thus more easily detectable) at lower resolutions of the same image.

In a first step, a high pass filter size is selected or determined (S705) according to image size. Generally, a larger filter size is associated with images of higher resolution. Longer filter lengths are more sensitive to edges and can thus detect weaker edges. A high pass filter can be adapted to be longer for larger image sizes. A reason is that correlation between neighboring pixels is stronger in larger images and thus weaker edges cannot be detected with a shorter high pass filter. In some embodiments, filters of different lengths available to the coding system are predefined, and the filters can be selected according to the image size (e.g., based on width and/or height of the image).

In a second step, a gradient is estimated (S710) in horizontal and vertical directions by applying a high pass filter such as a Sobel filter or a Difference of Gaussian (DOG) filter in each direction. A filter applied in one direction may be different from or may be the same as a filter applied in another direction. Gradient values along the horizontal and vertical directions can be denoted as gₓ (horizontal gradient) and g_{y} (vertical gradient), respectively. A gradient magnitude can be obtained using, for instance, |g|=|gₓ|+|g_{y}| or, alternatively, |g|=\sqrt{gₓ²+g_{y}²}. A gradient direction θ can be obtained through tan(θ)=g_{y}/gₓ. It should be noted that if the gradient magnitude of a particular pixel is above a threshold (to be described below), the particular pixel can be identified as an edge with an edge direction along the direction of the gradient direction.

After estimating the gradients value, two thresholds (denoted Th0 and Th1) used for edge detection can be estimated (S715) from a cumulative gradient magnitude histogram.

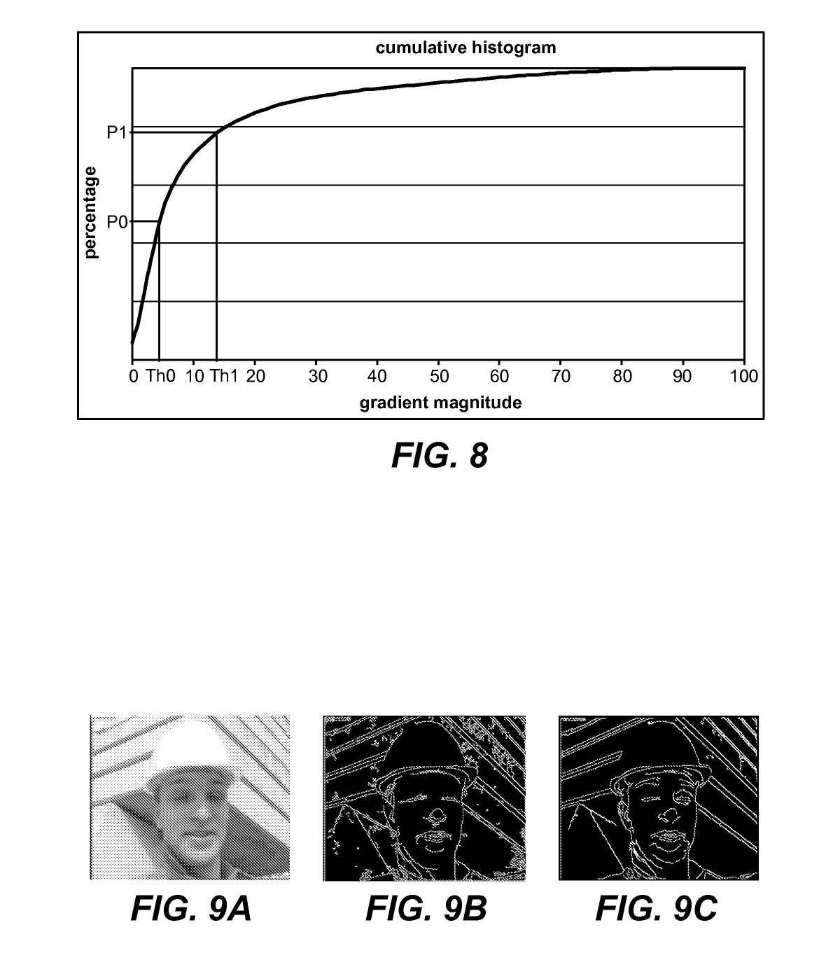

FIG. 8 shows threshold estimations based on a cumulative gradient magnitude histogram. The cumulative gradient magnitude histogram shown in FIG. 8 is obtained by normalizing gradient magnitude values to a value between 0 and 100; determining number of points (i.e., pixels) having each gradient magnitude value; and summing up the number of pixels with a gradient magnitude less than a particular gradient magnitude value to obtain the cumulative gradient magnitude. For instance, in the example cumulative gradient magnitude histogram shown in FIG. 8, around 70% of all points have a gradient magnitude less than 10.

In FIG. 8, threshold values Th0 and Th1, associated with percentages P0 and P1 respectively, are also shown. In general, low percentage P0 and high percentage P1 are set and then converted to threshold values Th0 and Th1 via a cumulative gradient magnitude histogram. The percentages P0 and P1 are application dependent and determine which pixels are classified as edges and which pixels are not. In FIG. 8, P0 is set to 50% and P1 is set to 85%.

The small threshold Th0 reduces effect of noise interference on edge detection since high pass filtering passes high frequency noise, which can be construed as edges. The large threshold Th1 is utilized as a threshold for detecting edge pixels with high confidence. Probability of a non-edge pixel having a gradient magnitude at a value of Th1 (or higher) should be relatively low.

As a result of the two threshold values, pixels can be categorized into three sets: non-edge set containing non-edge pixels, edge set containing edge pixels, and candidate set containing those pixels to be further validated. If a pixel's gradient magnitude is greater than Th1 and the gradient magnitude is a peak in the gradient direction, then the pixel is placed in the edge set. If the pixel's gradient magnitude is smaller than Th0, then it is put in the non-edge set. Otherwise, if a pixel cannot be placed in the edge set or non-edge set, the pixel is placed in the candidates set for further validation.

With reference back to FIG. 7, after all pixels are initially categorized, all pixels in the candidates set are categorized iteratively (S725). For a particular pixel in the candidates set, if there is a pixel containing an edge located in a neighboring area of the particular pixel, then the particular pixel can be placed in the edge set. Otherwise, the particular pixel in the candidates set is placed in the non-edge set. The neighboring area can be set, for example, as the four or eight nearest neighboring pixels. Other definitions of what constitutes a neighboring area can also be used.

According to other embodiments of the present disclosure, additional steps can be performed to aid in edge detection such as applying a denoising filter to video data. Such denoising, which can be performed, for instance, as a preprocessing step, can reduce effect of noise on edge detection. With further reference to FIG. 7, a multi-channel analysis (S730) and/or multi-resolution analysis (S735) can be performed on the image.

In the multi-channel analysis (S730), each step (S705, S710, S715, S720, S725) can be performed for each channel until all channels have been analyzed (S732). For example, analysis of the luma channel may generate one edge set and one non-edge set. The chroma channels (e.g., R, G, B) can also be analyzed to generate an edge set, non-edge set, and candidates set, where a particular pixel in the candidate set can then be further categorized (S725) into the edge set or the non-edge set based on chroma information of pixels neighboring the particular pixel. Whether or not multi-channel analysis (S730) is performed also depends on whether source image information contains these multiple channels.

After each channel analysis, number of edge detections can be obtained for each pixel. Specifically, in the case of three channels, each pixel can have a counter running between zero (none of the channels detect an edge) to three (all of the channels detect an edge). Only those edges with high confidence will be kept while those edges with low confidence will be removed. Those edges at intermediate confidence levels are further evaluated. As an example, these edges potentially associated with a pixel can be kept if neighboring pixels have been determined to contain edges.

Alternatively or in conjunction with multi-resolution analysis (S735), edges can be detected for different resolutions of the same image. Results are then mapped to original resolution of a present image under analysis. Each step (S705, S710, S715, S720, S725) is performed on each resolution until all resolutions have been analyzed (S737). For instance, if an image is downsampled to half the original resolution, then two pixels (e.g., A and B) in the original resolution become one pixel (e.g., E) at the downsampled resolution. If it is determined that E contains an edge, then A and B can also be considered to contain edges. Similarly, if it is determined that E does not contain an edge, then A and B can also be considered as not containing an edge. In some embodiments, a refinement can be applied based on results of a particular resolution. For instance, A and B are considered edge pixel candidates and can be further evaluated (e.g., checked at the original resolution) to determine whether A and B contain an edge.

To take into account both channels and resolutions, FIG. 7 shows an exemplary implementation where all channels of a particular resolution are analyzed prior to analyzing a next resolution. For some source images, only one of these two analyses (S730, S735) may make sense or may be performed. For instance, if a source image is monochromatic, then a multi-channel analysis (S730) would not provide additional information (or sometimes cannot be performed altogether) whereas a multi-resolution analysis (S735) can still be performed to provide additional edge detection information.

Results from each channel at each resolution can then be combined (S740) (e.g., via a linear combination with different or same weights applied to each channel and each resolution).

Once a final edge pixel set has been determined, edge length filtering (S745) can, but need not, be performed to exclude those edges that are sufficiently short in length. Specifically, a measurement of length is performed for each edge obtained from the edge detection process (known as the edge information). If the length is shorter than a set threshold, then the edge is removed (S747) from the edge information. The edge length filtering (S745) can be performed using a low pass filter and can reduce effect of noise. Classification of an edge as sufficiently short is arbitrary. However, threshold edge length is generally selected such that subjective visual quality is improved. Edges remaining after the low pass filtering can be referred to as relevant or salient edges.

FIGS. 9A-9C show one example of edge detection and edge length filtering. Specifically, FIG. 9A shows a source image on which edge detection is to be performed. FIG. 9B shows an edge map with no edge length filtering, which details the edges detected in the source image. Many small edges, which may be a result of noise and/or edges in the source image that are small, are visible in the edge map of FIG. 9B. FIG. 9C shows an edge map with edge length filtering. Visually, FIG. 9C provides a closer outline of the more visible edges present in FIG. 9A.

### 3. Deblocking Parameter Search

According to many embodiments of the present disclosure, a fast deblocking parameter search can be performed to select a deblocking parameter without searching the entire space of possible deblocking parameters.

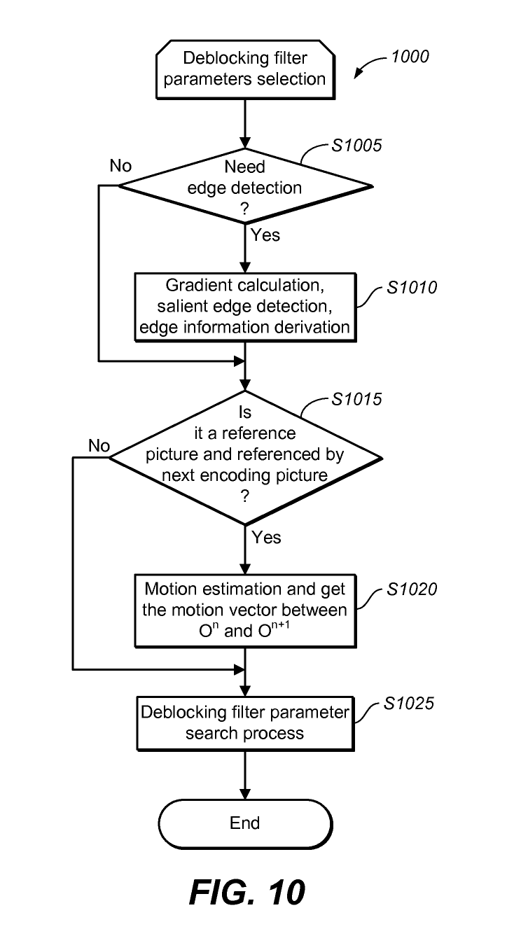

FIG. 10 shows an embodiment of a deblocking filter parameter selection process (1000). For a given image, if a particular analysis or particular video application involves use of edge detection (S1005), then gradient calculation, edge detection, and edge information derivation (S1010) can be performed. The gradient calculation, edge detection, and edge information derivation (S1010) performed can be similar to those steps (S705, S710, S715, S720, S725, S730, S735) performed in FIG. 7. Edge information includes information on an edge map indicating whether or not a pixel can be classified as an edge and an edge direction associated with each pixel classified as an edge.

For the same given image, if this particular image is utilized as a reference picture for coding of a subsequent picture (S1015), then motion estimation (S1020) can be performed on the particular image to obtain a motion vector. The motion vector can be used in motion compensation to predict a current original image Oⁿ⁺¹ based on a previous original image Oⁿ.

With reference back to equation (1), performance of edge detection (S1010) and/or motion estimation (S1020) is generally based on application. Specifically, distortion from edges and prediction (e.g., from motion compensation) are utilized in the calculation of distortion due to use of a particular deblocking parameter.

A deblocking filter parameter search process (S1025) is then performed based on evaluating some or all of the components in equation (1). The distortion D(p) is calculated for each deblocking parameter, and the deblocking parameter associated with a minimum D(p) is generally considered optimal. As an example, H.264 supports two deblocking parameters (p₁, p₂) for each region/slice of an image, where p₁ and p₂ are integers. It should be noted that while p₁ and p₂ both control the deblocking process of an image, the two-dimensionality of the parameters (p₁, p₂) are generally not associated with spatial dimensions of the image. A one-dimensional deblocking parameter space as well as a higher-dimensional deblocking parameter space can be defined instead.

In general, complexity and thus computational power/time is too high for most applications to check an entire parameter search space of possible deblocking parameters. The whole parameter search space is a valid range of values for the deblocking parameter. For instance, each index of p can be an integer within a range [−51, 51], where the indices identify a deblocking filter or filters to be utilized. In H.264, for instance, although actual application of the deblocking filter is standardized, the deblocking parameters (p₁, p₂) can be selected according to image/video content.

Fast search methods for the deblocking parameters p similar to fast motion estimation search methods provided in reference [3], incorporated herein by reference in its entirety, can be applied.

According to many embodiments in this disclosure, fast searching technology comprises one or more of search range adaption, early termination, and multi-scale searching (from coarse level to fine level searching).

Consider that the deblocking filter parameters p are of multiple dimensions, where the dimensions of p are generally not related to spatial dimensions. Let Nᵢ be number of possible values for p within a search range SR, in an i-th dimension and kⱼ be a scale number at a j-th scale level. A searching number, which provides number of values of p to be searched, of i-th dimension at j-th scale level is given by Nᵢ/kⱼ. Scale level 0 (k₀) is the coarsest level parameter search. Only those sub-sampled positions (i.e., the Nᵢ/kⱼ deblocking parameters) are checked. Subsequent to the coarsest level parameter search, a finer level parameter search (denoted k₁, k₂, and so forth) can then be performed. At each scale level, various search methods can be utilized such as full search and diamond search.

For search range adaptation, search range is determined by the previous picture's deblocking parameter, denoted as p′ᵢ, and given by

SRᵢ=min(abs(p′ᵢ)+ΔSRᵢ,Maxᵢ) (8)

where SRᵢ is the search range for an i-th dimension of a deblocking filter parameter p, p′ᵢ is the i-th dimension of the deblocking filter parameter used for deblocking filtering a previous image, ΔSRᵢ is a small value specified based on application, and Maxᵢ is a set maximum search window. Each of abs(p′ᵢ), ΔSRᵢ, and Maxᵢ is an integer, and their values can be obtained from a lookup table. A search range SRᵢ is the number of deblocking filter parameters from a set center of the search space along an i-th dimension. Some or all of the deblocking filters within the search range SRᵢ are evaluated.

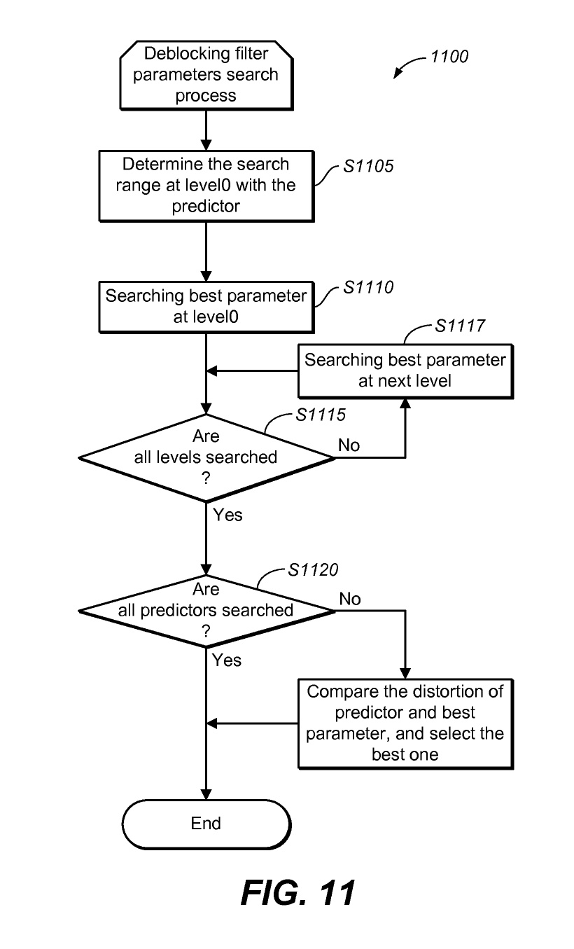

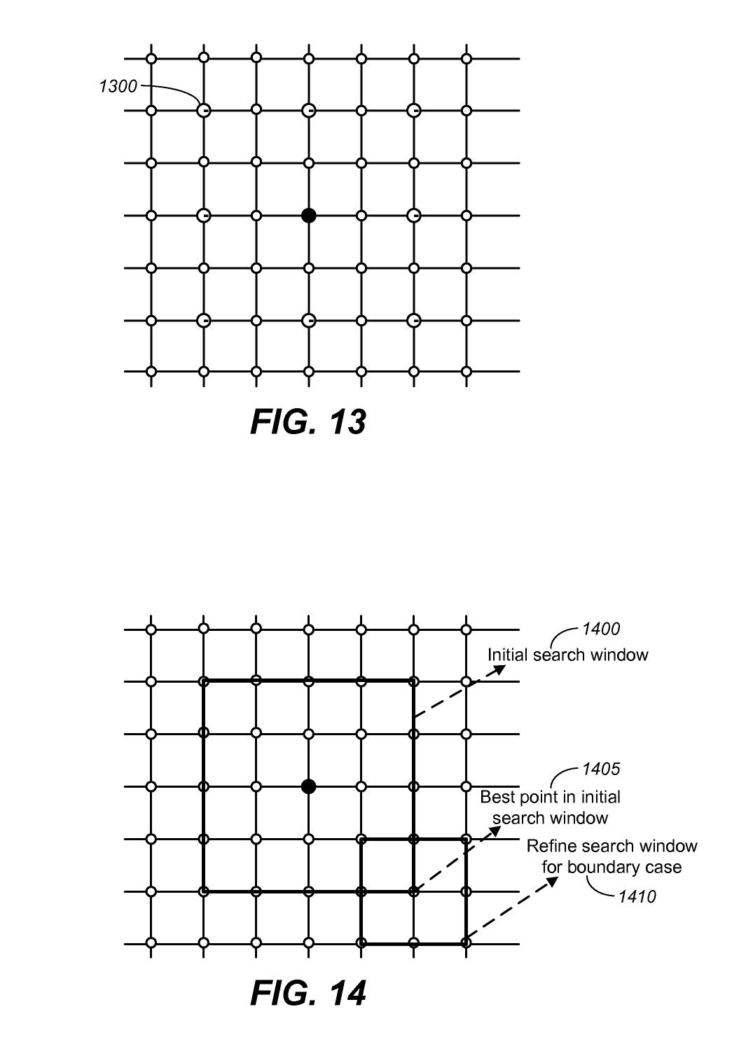

FIG. 11 shows an embodiment of a multi-scale deblocking filter parameter search and selection. With reference to FIG. 13, consider that each of the forty-nine circles represents a deblocking parameter p. A search center, also referred to as an origin, is provided by a gray circle. It is assumed that the search range is 3 in both the horizontal and vertical directions around the search center. Also, consider a scale number of k₀=2 at level 0 for both dimensions of the deblocking parameter search space.

In a first step (S1105), the search center at level 0 (k₀) can be determined using a predictor. The predictor provides an origin around which to perform a search. When a predictor is not available, a search center of (0, 0) is generally set as the default. Predictors are generally based on deblocking parameters selected from a picture or a region (e.g., a slice or sub-picture) of a present picture under consideration for which deblocking parameters have been determined. For instance, the search center for the deblocking parameter of the present picture or region thereof can be set to the deblocking parameter of a previous picture or the deblocking parameter of a region of the present picture. In cases with multiple predictors, one predictor can be selected, for instance, based on distortion associated with each predictor.

In a second step (S1110), each possible deblocking filter parameter that is part of the level 0 set can be evaluated. The evaluation can be, for example, taking each of these possible deblocking filter parameters and calculating D(p) in accordance with equation (1). An optimal deblocking parameter is generally one that minimizes D(p) at the given level. However, early termination of the search can be implemented such that the search ends when a deblocking parameter p associated with a sufficiently low D(p) (e.g., a set threshold for D(p)) is found. With reference to FIG. 13, k₀=2 and thus the search center and every other point from the search center is evaluated. Specifically, deblocking parameters depicted as the larger circles (e.g., 1300), including the search center, can be evaluated. Order in which the deblocking parameters are evaluated can be given, for instance, by a spiral search order. A spiral search order can be used to evaluate deblocking parameters a certain distance from the search center in order from closest to farthest (within the search range) from the search center, where it should be noted that deblocking parameters closer to the search center are generally associated with a smaller number of coding bits.

In a third step (S1115), a determination is made as to whether all levels have been searched. If not, each possible deblocking filter parameter for each level considered is evaluated to find a best deblocking parameter (S1117). With reference to FIG. 13, k₁=1 and thus every point of the forty-nine points is evaluated. It should be noted that the search range can be scaled at different levels. For instance, if the search range at level 0 is 10, then the search range at level 1 can be given by, for instance, 10/(k₀/k₁).

Each of the above steps (S1105, S1110, S1115, S1117) is performed for each predictor until the deblocking filter parameter search is performed using all the predictors (S1120), where the predictors provide the starting search center for each search process. An optimal p can be obtained after searching through the search space at each level for each predictor. In general, for each different level search, the predictor and the search range changes. Generally, the search range gets smaller at each subsequent level (e.g., Nᵢ>Nᵢ₊₁) and similarly the scale number gets smaller at each subsequent level (e.g., kᵢ>kᵢ₊₁). The scale number generally is set to unity (e.g., search every point in the search window) only for a last level search.

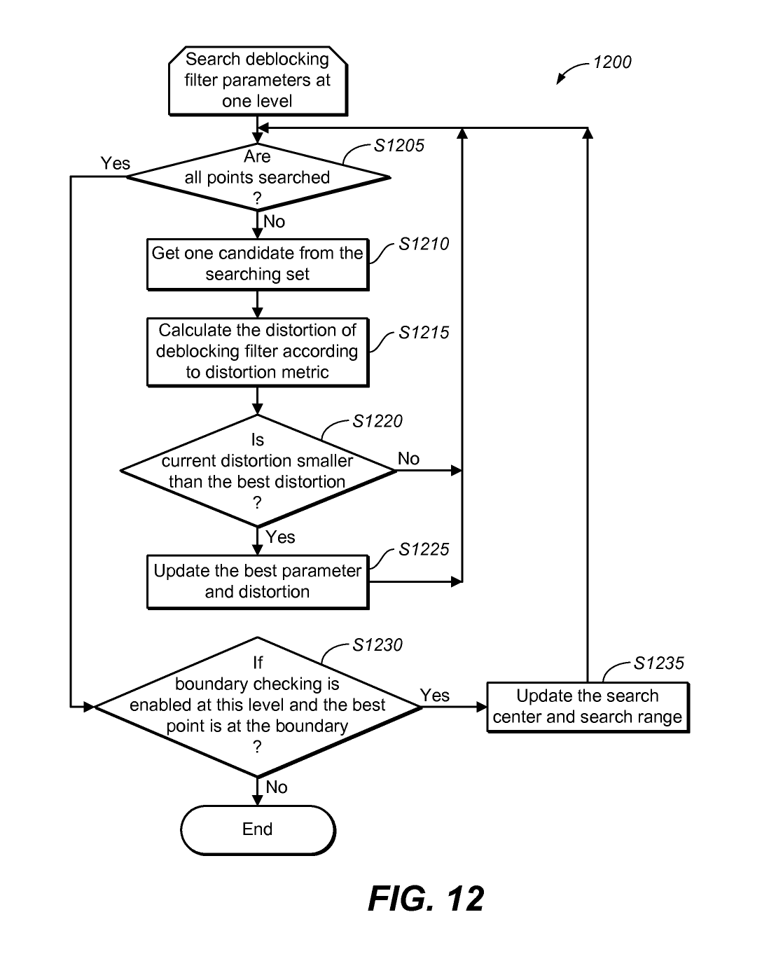

FIG. 12 shows an embodiment of a deblocking filter parameter search process at one scale level. Within a boundary provided by a search range about a search center, each deblocking parameter can be evaluated. For each deblocking parameter within the boundary, a deblocking parameter can be selected (S1210) and a measure of distortion associated with the deblocking parameter can be obtained (S1215). In many embodiments of the present disclosure, the distortion measurement can be calculated based on equation (1). The calculated distortion can be compared (S1220) with a presently stored minimum distortion based from previously evaluated deblocking parameters. If the calculated distortion is determined to be smaller than the presently stored minimum distortion, this new minimum distortion and the deblocking parameter associated with the minimum distortion is stored (S1225). Minimum distortion and deblocking parameter associated with the minimum distortion is updated (S1225) as each deblocking parameter is evaluated.

In some embodiments, to avoid an insufficient search range setting, if the deblocking filter parameter associated with minimum distortion is at a boundary of a search window (S1230), then a boundary refinement search is performed (S1235). The boundary refinement search involves updating the starting center search and search range. Generally, the search range is made smaller than or of the same size as prior to the boundary refinement search. Deblocking filter parameters within a boundary around this new starting center search are evaluated.

It should be noted that the deblocking process is generally a non-linear process. On a small scale, any plurality of deblocking parameters that are close to each other are not necessarily associated with similar distortion values. However, on a large scale, for any two points in the parameter space that are far from each other, distortion values associated with each of the two points in the parameter space are generally different from each other.

FIG. 14 shows an example of a boundary refinement search, where a deblocking filter parameter is located at a boundary defined by a search range. An initial search window (1400) is provided, where each deblocking parameter within the initial search window (1400) can be evaluated. Specifically, the initial search window has a search range of two about the search center (shown as a gray circle). Within the initial search window (1400), a deblocking parameter associated with minimum distortion is found at a boundary point (1405). The deblocking parameter at the boundary point (1405) is set as the new search center around which a refined search window (1410) is formed. Specifically, the refined search window (1410) has a search range of one about the new search center (1405). It should be noted that the search range of the refined search window (1410) is generally set to be the same or smaller than the search range of a previous search window (e.g., 1400). The boundary refinement search can be repeated until a deblocking filter parameter associated with minimum (or sufficiently low) distortion is not at a boundary or no further boundary refinement can be performed.

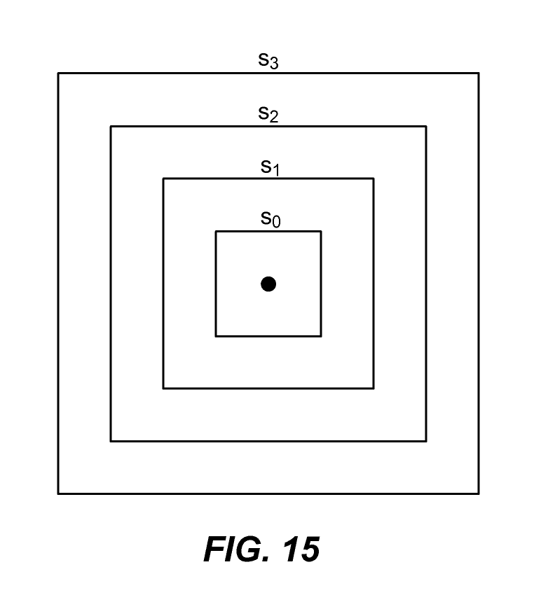

FIG. 15 shows a spiral search order for searching and selecting deblocking filter parameters. Generally, deblocking parameters in inner search windows, such as s₀ and s₁, around the search center are evaluated prior to those in outer search windows, such as s₂ and s₃. Each level of the search is defined by a search center, a search window, a scale number, and a deblocking parameter associated with a best distortion (e.g., minimum distortion). As each level is evaluated, a best distortion corresponds to the best distortion among all the evaluated levels thus far and can be referred to as a global best distortion. In each search window, deblocking parameters associated with minimal distortion are identified.

In some embodiments, an early termination condition can be defined in that if the best distortion of search window is sufficiently greater than the present minimal distortion, then the search will stop for the present level and continue to a search at a next level. An exemplary threshold for “sufficiently greater” is that when a particular distortion of the search window is about 1.1 times larger than the present minimal distortion, then this particular distortion is considered “sufficiently greater” and the search can be stopped for the present level and continued at the next level.

By way of example, consider a set of deblocking parameters to be checked for a present level. If a distortion associated with a particular deblocking parameter in the set is much greater than the present minimal distortion, then the evaluation of deblocking parameters can be ended for the present level. Otherwise, further evaluation of the set of deblocking parameters for the present level can be performed.

A search pattern, which is the shape of a search window, such as square, diamond, and hexagon, at other levels can be selected according to predefined settings (e.g., specification for speed and/or quality). The search strategy can also vary according to the speed and/or quality requirement. In terms of speed, a search performed on a diamond shaped search pattern is generally faster than a search performed on a hexagon shaped search pattern, which in turn is generally faster than a search performed on a square shaped search pattern. In terms of quality of results, a search performed on a square shaped search pattern is generally of higher quality than a search performed on a hexagon shaped search pattern, which in turn is generally of higher quality than a search performed on a diamond shaped search pattern. Each of search pattern and search strategy can be selected based on a particular application.

Other implementations of a fast search are possible. For instance, boundary refinement can be performed only once after evaluation at level 0. As such, if the deblocking parameter associated with minimum distortion is at a boundary point for the initial search window, neighboring parameters around the new search center can be evaluated in the refined search window. If the deblocking parameter associated with minimum distortion is again at a boundary, no further boundary refinements are performed and the boundary point is considered the optimal deblocking parameter. Other possibilities can involve performing boundary refinement a set number of times. To obtain better search results (e.g., deblocking parameters associated with lower distortion), an iterative refinement search can be performed. Specifically, if a present best position is not a starting search center, then the present best position can be set as the starting search center around which a subsequent search can be performed. In some cases, the iterative refinement search can be performed only up to a set maximum number of times.

The methods and systems described in the present disclosure may be implemented in hardware, software, firmware, or combination thereof. Features described as blocks, modules, or components may be implemented together (e.g., in a logic device such as an integrated logic device) or separately (e.g., as separate connected logic devices). The software portion of the methods of the present disclosure may comprise a computer-readable medium which comprises instructions that, when executed, perform, at least in part, the described methods. The computer-readable medium may comprise, for example, a random access memory (RAM) and/or a read-only memory (ROM). The instructions may be executed by a processor (e.g., a digital signal processor (DSP), an application specific integrated circuit (ASIC), or a field programmable logic array (FPGA)).

All patents and publications mentioned in the specification may be indicative of the levels of skill of those skilled in the art to which the disclosure pertains. All references cited in this disclosure are incorporated by reference to the same extent as if each reference had been incorporated by reference in its entirety individually.

The examples set forth above are provided to give those of ordinary skill in the art a complete disclosure and description of how to make and use the embodiments of the subjective based post-filter optimization of the disclosure, and are not intended to limit the scope of what the inventors regard as their disclosure. Modifications of the above-described modes for carrying out the disclosure may be used by persons of skill in the video art, and are intended to be within the scope of the following claims.

It is to be understood that the disclosure is not limited to particular methods or systems, which can, of course, vary. It is also to be understood that the terminology used herein is for the purpose of describing particular embodiments only, and is not intended to be limiting. As used in this specification and the appended claims, the singular forms “a”, “an”, and “the” include plural referents unless the content clearly dictates otherwise. Unless defined otherwise, all technical and scientific terms used herein have the same meaning as commonly understood by one of ordinary skill in the art to which the disclosure pertains.

A number of embodiments of the disclosure have been described. Nevertheless, it will be understood that various modifications may be made without departing from the spirit and scope of the present disclosure. Accordingly, other embodiments are within the scope of the claims.

An embodiment of the present invention may related to one or more of the example embodiments, which are enumerated in Table 2, below. Accordingly, the invention can be embodied in any of the forms described herein, including, but not limited to the following enumerated example embodiments (EEEs), which describe structures, features and functionalities of some portions of the present invention.

TABLE 2
ENUMERATED EXAMPLE EMBODIMENTS

EEE1. A method for selection of an optimal deblocking parameter associated with an optimal
deblocking filter, the optimal deblocking filter configured to be applied to a particular region
in an image, the method comprising:
providing an present input image, wherein the present input image is adapted to be
partitioned into regions;
providing a plurality of deblocking parameters, wherein each deblocking parameter is
associated with a deblocking filter;
generating a present coded image based on the present input image;
selecting one deblocking parameter from the plurality of deblocking parameters;
applying the deblocking filter associated with the selected deblocking parameter on a
particular region in the present coded image to obtain present deblocked data;
evaluating distortion associated with the selected deblocking parameter based on a
difference between the present deblocked data and a corresponding region in the present
input image; and
iteratively performing the selecting, applying, and evaluating on some or all of the remaining
deblocking parameters in the plurality of deblocking parameters,
wherein the optimal deblocking parameter associated with the optimal deblocking filter is
selected from among the selected deblocking parameters based on distortion evaluated for
each selected deblocking parameter.
EEE 2. A method for selection of an optimal deblocking parameter associated with an
optimal deblocking filter, the optimal deblocking filter configured to be applied to a
particular region in an image, the method comprising:
providing an present input image, wherein the present input image is adapted to be
partitioned into regions;
providing a plurality of deblocking parameters, wherein each deblocking parameter is
associated with a deblocking filter;
generating a present coded image based on the present input image;
determining a starting search center, wherein the starting search center is associated with a
deblocking parameter among the plurality of deblocking parameters;
determining a search range, wherein the search range determines number of deblocking
parameters in the plurality of deblocking parameters around the starting search center to
select;
selecting one deblocking parameter among the plurality of deblocking parameters
within the search range around the starting search center;
applying the deblocking filter associated with the selected deblocking parameter on a
particular region in the present coded image to obtain present deblocked data;
evaluating distortion associated with the selected deblocking parameter based on a difference
between the present deblocked data and a corresponding region in the present input image; and
iteratively performing the selecting, applying, and evaluating on some or all of the remaining
deblocking parameters within the search range around the starting search center,
wherein the optimal deblocking parameter associated with the optimal deblocking filter is
selected from among the selected deblocking parameters based on distortion evaluated for
each selected deblocking parameter.
EEE 3. The method according to EEE 2, further comprising:
providing one or more search levels, wherein each search level determines number of
deblocking parameters within the search range around the starting search center to select; and
iteratively performing the selecting, applying, and evaluating on the deblocking
parameters within the search range around the starting search center for each search level.
EEE 4. The method according to any one of EEEs 2-3, wherein the starting search center is
based on deblocking parameters selected for previously coded image data.
EEE5. The method according to any one of EEEs 2-4, wherein if the optimal deblocking
parameter is at a distance of the search range from the starting search center, the method
further comprises:
setting a refined starting search center, wherein the new starting search center is associated
with the optimal deblocking parameter;
providing a refined search range, wherein the refined search range determines number of
deblocking parameters around the refined starting search center to select;
providing a refined search level, wherein the refined search level determines number of
deblocking parameters within the search range around the refined starting search center to
select; and
iteratively performing the selecting, applying, and evaluating on the deblocking parameters
within the refined search range around the refined starting search center for the refined search level,
wherein a refined deblocking parameter is the deblocking parameter among the selected
deblocking parameters associated with minimum distortion.
EEE6. The method according to any one of the previous EEEs, wherein the generating the
present coded image comprises:
performing motion estimation and mode selection on reference data in a reference
picture buffer and the present input image to obtain prediction parameters;
generating a present prediction image based on the prediction parameters;
subtracting the present input image from the present prediction image to generate
residual information; and
adding the residual information with the present prediction image to generate the
present coded image,
wherein the present coded image is adapted to be stored in the reference picture buffer.
EEE7. The method according to any one of the previous EEEs, further comprising encoding
the selected deblocking parameter to obtain an encoded deblocking parameter, wherein the
evaluating distortion is further based on rate of the encoded deblocking parameter.
EEE8. The method according to any one of the previous EEEs, wherein the evaluating
distortion is based on a difference between particular pixels in the particular region in the
present input image and corresponding pixels in the present deblocked data.
EEE9. The method according to EEE 8, wherein the particular pixels in the present input
image and the corresponding pixels in the present deblocked data are not along block
boundaries.
EEE10. The method according to any one of the previous EEEs, further comprising:
providing a subsequent input image, wherein the subsequent input image is adapted to be
partitioned into regions and is subsequent in time to the present input image; and
generating a prediction of the subsequent input image through motion compensation of the
present deblocked data to obtain a subsequent predicted image,
wherein the evaluating distortion is further based on a difference between the subsequent
input image and the subsequent predicted image.
EEE11. The method according to any one of EEEs 8-10, further comprising:
performing edge detection on the present input image, thus detecting a plurality of
edges associated with the present input image,
wherein the particular pixels in the present input image and the corresponding pixels
in the present deblocked data are along region boundaries but do not contain an edge from the
plurality of edges.
EEE12. The method according to EEE 11, wherein the evaluating distortion is further based
on a difference between neighboring pixels of the particular pixels in the present deblocked
data and the particular pixels in the present deblocked data.
EEE13. The method according to EEE 12, wherein a weight is applied to the difference
between the neighboring pixels of the particular pixels in the present deblocked data and the
particular pixels in the present deblocked data, and wherein the weight is a function of the
difference between the neighboring pixels of the particular pixels in the present deblocked
data and the particular pixels in the present deblocked data.
EEE14. The method according to EEE 13, wherein the weight is selected from the group
consisting of a Gaussian distribution, Lorentzian distribution, Laplace distribution, and
uniform distribution.
EEE15. The method according to any one of EEEs 8-10, further comprising:
performing edge detection on the present input image, thus detecting a plurality of
edges associated with the present input image,
wherein the particular pixels in the present input image and the corresponding pixels
in the present deblocked data are along region boundaries and contain at least one edge from
the plurality of edges.
EEE16. The method according to any one of EEEs 11-15, wherein the performing edge
detection comprises:
selecting a high pass filter to be applied to each pixel in the present input image,
wherein filter size of the high pass filter is based on size of the present input image;
generating gradient magnitude values for each pixel in the present input image by
applying the high pass filter to each pixel; and
classifying each pixel as containing an edge or not containing an edge based on the
gradient magnitude values associated with each pixel.
EEE17. The method according to EEE 16, further comprising, before the classifying,
estimating a first threshold value and a second threshold value based on a gradient magnitude
histogram, wherein:
the gradient magnitude histogram is based on distribution of the gradient magnitude values
for the pixels in the present input image,
the first threshold value is of lower magnitude than the second threshold value, and
the classifying each pixel is based on a comparison between the gradient magnitude of
a particular pixel with the two threshold values.
EEE18. The method according to EEE 17, wherein:
a particular pixel is classified as containing an edge if the gradient magnitude value of the
particular pixel is higher than the second threshold value, and
a particular pixel is classified as not containing an edge if the gradient magnitude value of the
particular pixel is lower than the first threshold value.
EEE19. The method according to EEE 17 or 18, wherein, for a particular pixel with a
gradient magnitude between the first threshold value and the second threshold value:
the particular pixel is classified as containing an edge if one or more neighboring pixels are
classified as containing an edge, and
the particular pixel is classified as not containing an edge if none of its neighboring pixels are
classified as containing an edge.
EEE20. The method according to any one of EEEs 11-19, wherein:
each pixel contains information in multiple channels,
the performing edge detection is performed for each pixel based on information from each
channel, and
each channel is a luma channel or a chroma channel.
EEE21. The method according to EEE 20, wherein the performing edge detection is
performed for each pixel based on a combination of the information from each channel.
EEE22. The method according to any one of EEEs 11-21, further comprising generating a set
of downsampled images, each downsampled image being a downsampled version of the
present input image, wherein the performing edge detection is performed for each
downsampled image.
EEE23. The method according to any one of EEEs 11-22, further comprising:
determining length of each edge in the plurality of edges; and
declassifying the edges with lengths shorter than a threshold length from the plurality of
edges associated with the present input image.
EEE24. The method according to any one of the previous EEEs, wherein the iteratively
performing comprises performing the selecting, applying, and evaluating for all the provided
deblocking parameters.
EEE25. The method according to any one of EEEs 1-23, wherein the selecting one
deblocking parameter comprises selecting a particular deblocking parameter based on a
deblocking parameter selected for previous deblocked data.
EEE26. The method according to EEE 25, wherein the iteratively performing comprises:
selecting a deblocking parameter neighboring the particular deblocking parameter;
applying the deblocking filter associated with the selected deblocking parameter; and
evaluating distortion associated with the selected deblocking parameter,
wherein each deblocking parameter lies in a discrete deblocking parameter space.
EEE27. The method according to any one of EEEs 1-25, wherein the iteratively performing
comprises performing the selecting, applying, and evaluating for less than an entirety of the
provided deblocking parameters.
EEE28. The method according to any one of the previous EEEs, further comprising:
determining computational complexity of the applying the deblocking filter,
wherein the evaluating distortion is further based on the computational complexity.
EEE29. The method according to any one of the previous EEEs, wherein the optimal
deblocking parameter is the deblocking parameter among the selected deblocking parameters
associated with minimum distortion.
EEE30. An encoder configured to perform deblocking filtering on image data based on
deblocking parameters, the encoder comprising:
a reference picture buffer containing reference image data;
a motion estimation and mode selection unit configured to generate prediction parameters
based on input image data and the reference image data;
a predictor unit configured to generate predicted image data based on the prediction
parameters;
a subtraction unit configured to take a difference between the input image data and the
predicted image data to obtain residual information;
a transformation unit and quantization unit configured to receive the residual information and
configured to perform a transformation and quantization of the residual information;
an inverse quantization unit and an inverse transformation unit configured to receive an
output of the quantization unit and configured to perform inverse transformation and
quantization on the output of the quantization unit;
an adder configured to sum the output of the inverse transformation unit and the predicted
image data to obtain combined image data; and
a deblocking filtering unit configured to receive the combined image data and configured to
perform deblocking on the combined image data based on the deblocking parameters, the
deblocking filtering unit being configured to obtain the deblocking parameters by performing
the method according to any one of claims 1-29, wherein an output of the deblocking filtering
unit is adapted to be stored in the reference picture buffer.
EEE31. The encoder according to EEE 30, further comprising an entropy coding unit
configured to receive an output of the quantization unit, wherein the entropy coding unit is
configured to output a bitstream comprising information on the residual information.
EEE32. A decoder adapted to receive a bitstream from the encoder of EEE 31, the decoder
comprising:
a reference picture buffer containing reference image data;
an entropy decoding unit configured to decode the bitstream;
an inverse quantization unit and an inverse transformation unit configured to receive
an output of the entropy decoding unit and configured to perform inverse quantization and
inverse transformation on the residual information in the bitstream;
a predictor unit configured to generate predicted image data based on the prediction
parameters from the bitstream;
an adder configured to sum an output of the inverse transformation unit and the predicted
image data to obtain combined image data; and
a deblocking filtering unit configured to receive the combined image data based on the
deblocking parameters from the bitstream, wherein an output of the deblocking filtering unit
is adapted to be stored in the reference picture buffer.
EEE33. A computer-readable medium containing a set of instructions that causes a computer
to perform the method recited in one or more of EEEs 1-29.
EEE34. Use of the method recited in one or more of EEEs 1-29 to select deblocking
parameters to be applied to a particular region of an image.

### LIST OF REFERENCES

[1] Advanced video coding for generic audiovisual services, world wide website itu.int/rec/recommendation.asp?type=folders&lang=e&parent=T-REC-H.264, March 2010. URL verified Nov. 18, 2011.
[2] G. J. Sullivan and T. Wiegand, “Rate-distortion optimization for video compression”, IEEE Signal Processing Magazine, vol. 15, issue 6, November 1998.
[3] H. C. Tourapis, A. Tourapis, “Fast Motion Estimation within H.264 Codec”, Proceedings of the 2003 International Conference on Multimedia and Expo—Volume 3, pp. 517-520, 2003.
[4] Y.-L. Lee and H. W. Park, “Loop filtering and post-filtering for low-bit rates moving picture coding”, Signal Processing: Image Communication., vol. 16, pp. 871-890, 2001.
[5] S. D. Kim, J. Yi, H. M. Kim, and J. B. Ra, “A deblocking filter with two separate modes in block-based video coding”, IEEE Trans. Circuits Syst. Video Technology, vol. 9, pp. 156-160, February 1999.

1. A method for selection of an optimal deblocking parameter associated with an optimal deblocking filter, the optimal deblocking filter configured to be applied to a particular region in an image, the method comprising:
providing an present input image, wherein the present input image is adapted to be partitioned into regions;
providing a plurality of deblocking parameters, wherein each deblocking parameter is associated with a deblocking filter;
generating a present coded image based on the present input image;
determining a starting search center, wherein the starting search center is associated with a deblocking parameter among the plurality of deblocking parameters;
determining a search range, wherein the search range determines number of deblocking parameters in the plurality of deblocking parameters around the starting search center to select;
selecting one deblocking parameter among the plurality of deblocking parameters within the search range around the starting search center;
applying the deblocking filter associated with the selected deblocking parameter on a particular region in the present coded image to obtain present deblocked data;
evaluating distortion associated with the selected deblocking parameter based on a difference between the present deblocked data and a corresponding region in the present input image; and
iteratively performing the selecting, applying, and evaluating on some or all of the remaining deblocking parameters within the search range around the starting search center,
wherein the optimal deblocking parameter associated with the optimal deblocking filter is selected from among the selected deblocking parameters based on distortion evaluated for each selected deblocking parameter.

2. The method according to claim 1, further comprising:
providing one or more search levels, wherein each search level determines number of deblocking parameters within the search range around the starting search center to select; and
iteratively performing the selecting, applying, and evaluating on the deblocking parameters within the search range around the starting search center for each search level.

3. The method according to claim 1, wherein the starting search center is based on deblocking parameters selected for previously coded image data.

4. The method according to claim 1, wherein if the optimal deblocking parameter is at a distance of the search range from the starting search center, the method further comprises:
setting a refined starting search center, wherein the new starting search center is associated with the optimal deblocking parameter;
providing a refined search range, wherein the refined search range determines number of deblocking parameters around the refined starting search center to select;
providing a refined search level, wherein the refined search level determines number of deblocking parameters within the search range around the refined starting search center to select; and
iteratively performing the selecting, applying, and evaluating on the deblocking parameters within the refined search range around the refined starting search center for the refined search level,
wherein a refined deblocking parameter is the deblocking parameter among the selected deblocking parameters associated with minimum distortion.

5. The method according to claim 1, wherein the generating the present coded image comprises:
performing motion estimation and mode selection on reference data in a reference picture buffer and the present input image to obtain prediction parameters;
generating a present prediction image based on the prediction parameters;
subtracting the present input image from the present prediction image to generate residual information; and
adding the residual information with the present prediction image to generate the present coded image,
wherein the present coded image is adapted to be stored in the reference picture buffer.

6. The method according to claim 1, further comprising encoding the selected deblocking parameter to obtain an encoded deblocking parameter, wherein the evaluating distortion is further based on rate of the encoded deblocking parameter.

7. The method according to claim 1, wherein the evaluating distortion is based on a difference between particular pixels in the particular region in the present input image and corresponding pixels in the present deblocked data.

8. The method according to claim 7, wherein the particular pixels in the present input image and the corresponding pixels in the present deblocked data are not along block boundaries.

9. The method according to claim 1, further comprising:
providing a subsequent input image, wherein the subsequent input image is adapted to be partitioned into regions and is subsequent in time to the present input image; and
generating a prediction of the subsequent input image through motion compensation of the present deblocked data to obtain a subsequent predicted image,
wherein the evaluating distortion is further based on a difference between the subsequent input image and the subsequent predicted image.

10. The method according to claim 9, further comprising:
performing edge detection on the present input image, thus detecting a plurality of edges associated with the present input image,
wherein the particular pixels in the present input image and the corresponding pixels in the present deblocked data are along region boundaries but do not contain an edge from the plurality of edges.

11. The method according to claim 10, wherein the evaluating distortion is further based on a difference between neighboring pixels of the particular pixels in the present deblocked data and the particular pixels in the present deblocked data.

12. The method according to claim 9, further comprising:
performing edge detection on the present input image, thus detecting a plurality of edges associated with the present input image,
wherein the particular pixels in the present input image and the corresponding pixels in the present deblocked data are along region boundaries and contain at least one edge from the plurality of edges.

13. The method according to claim 2, wherein the iteratively performing comprises performing the selecting, applying, and evaluating for all the provided deblocking parameters.

14. A method for selection of an optimal deblocking parameter associated with an optimal deblocking filter, the optimal deblocking filter configured to be applied to a particular region in an image, the method comprising:
providing an present input image, wherein the present input image is adapted to be partitioned into regions;
providing a plurality of deblocking parameters, wherein each deblocking parameter is associated with a deblocking filter;
generating a present coded image based on the present input image;
selecting one deblocking parameter from the plurality of deblocking parameters;
applying the deblocking filter associated with the selected deblocking parameter on a particular region in the present coded image to obtain present deblocked data;
evaluating distortion associated with the selected deblocking parameter based on a difference between the present deblocked data and a corresponding region in the present input image; and
iteratively performing the selecting, applying, and evaluating on some or all of the remaining deblocking parameters in the plurality of deblocking parameters,
wherein the optimal deblocking parameter associated with the optimal deblocking filter is selected from among the selected deblocking parameters based on distortion evaluated for each selected deblocking parameter.

15. An encoder configured to perform deblocking filtering on image data based on deblocking parameters, the encoder comprising:
a reference picture buffer containing reference image data;
a motion estimation and mode selection unit configured to generate prediction parameters based on input image data and the reference image data;
a predictor unit configured to generate predicted image data based on the prediction parameters;
a subtraction unit configured to take a difference between the input image data and the predicted image data to obtain residual information;
a transformation unit and quantization unit configured to receive the residual information and configured to perform a transformation and quantization of the residual information;
an inverse quantization unit and an inverse transformation unit configured to receive an output of the quantization unit and configured to perform inverse transformation and quantization on the output of the quantization unit;
an adder configured to sum the output of the inverse transformation unit and the predicted image data to obtain combined image data; and
a deblocking filtering unit configured to receive the combined image data and configured to perform deblocking on the combined image data based on the deblocking parameters, the deblocking filtering unit being configured to obtain the deblocking parameters, wherein an output of the deblocking filtering unit is adapted to be stored in the reference picture buffer.

16. The encoder according to claim 15, further comprising an entropy coding unit configured to receive an output of the quantization unit, wherein the entropy coding unit is configured to output a bitstream comprising information on the residual information.

17. A decoder comprising:
a reference picture buffer containing reference image data;
an entropy decoding unit configured to decode the bitstream;
an inverse quantization unit and an inverse transformation unit configured to receive an output of the entropy decoding unit and configured to perform inverse quantization and inverse transformation on the residual information in the bitstream;
a predictor unit configured to generate predicted image data based on the prediction parameters from the bitstream;
an adder configured to sum an output of the inverse transformation unit and the predicted image data to obtain combined image data; and
a deblocking filtering unit configured to receive the combined image data and configured to perform deblocking on the combined image data based on the deblocking parameters from the bitstream, wherein an output of the deblocking filtering unit is adapted to be stored in the reference picture buffer.

18. A computer-readable medium containing a set of instructions that causes a computer to perform the method recited in claim 1.

19. Use of the method recited in claim 1 to select deblocking parameters to be applied to a particular region of an image.
